(19) United States
(12) Patent Application Publication
(10) Pub. No.: US 2014/0246982 A1
(43) Pub. Date: Sep. 4, 2014

(54) DISPLAY DEVICE, AND DISPLAY DEVICE CONTROL METHOD

(71) Applicants: Ryoh Araki, Osaka-shi (JP); Shigenori Tanaka, Osaka-shi (JP); Yoshinobu Hirayama, Osaka-shi (JP); Toshihiro Yanagi, Osaka-shi (JP)

(72) Inventors: Ryoh Araki, Osaka-shi (JP); Shigenori Tanaka, Osaka-shi (JP); Yoshinobu Hirayama, Osaka-shi (JP); Toshihiro Yanagi, Osaka-shi (JP)

(73) Assignee: SHARP KABUSHIKI KAISHA, Osaka-shi, Osaka (JP)

(21) Appl. No.: 14/112,329

(22) PCT Filed: Apr. 16, 2012
(86) PCT No.: PCT/JP2012/060284

§ 371 Date: Oct. 17, 2013

(30) Foreign Application Priority Data
Apr. 22, 2011 (JP) 2011-096585

(51) Int. Cl. G09G 3/34

(52) U.S. Cl. CPC G09G 3/3406
USPC 315/151

(57) ABSTRACT

A display device (100) includes a sensor (6A) which measures luminance of light emitted from a display region at an A side of a display section (5), a sensor (6B) which measures luminance of light emitted from a display region at a B side of the display section (5), and an operation section (7) which, in accordance with a result of the measurement by the sensors (6A) and (6B), decreases luminance of an LED (4A) or LED (4B) which illuminates a display region from which light with higher luminance is emitted, and/or increases luminance of an LED (4A) or LED (4B) which illuminates a display region from which light with lower luminance is emitted.

### TECHNICAL FIELD

The present invention relates to a display device including a plurality of light sources which illuminate different display regions, and to a method for controlling the display device.

### BACKGROUND ART

A conventional display device including a display section that is a so-called single view display displaying one image generally has a peak in luminance in a directly front direction (viewing angle 0°).

On the other hand, Patent Literature 1 discloses a so-called dual view display which enables a plurality of viewers to view different information displayed on the same display.

It is preferable that the display device including a display section which displays a plurality of images, which display section is represented by the display disclosed in Patent Literature 1, has peaks in luminance at different angles for individual display regions displaying images, respectively. Furthermore, it is preferable to design the display device such that the plurality of images displayed in individual display regions, respectively, have the same luminance (panel luminance) and individual images have the same appearance.

A light source device disclosed in Patent Literature 2 includes a light-emitting unit array consisting of a plurality of light-emitting units, and is capable of individually controlling luminances of the light-emitting units. Furthermore, the light source device disclosed in Patent Literature 2 can equalize luminance of the array of the light-emitting units.

### CITATION LIST

### Patent Literatures

### [Patent Literature 1]

Japanese Patent Application Publication No. 2004-206089 (published on Jul. 22, 2004)

### [Patent Literature 2]

Japanese Patent Application Publication No. 2009-54566 (published on Mar. 12, 2009)

### SUMMARY OF INVENTION

### Technical Problem

A display device including a display section which displays a plurality of images is required to have a plurality of light sources which illuminate different display regions.

There is a problematic possibility that in such a display device, images displayed in individual display regions have different luminances due to variation between the plurality of light sources etc. The display disclosed in Patent Literature 1 does not have a measure against such a problem.

Although the light source device disclosed in Patent Literature 2 can sense and control luminances of individual light-emitting units, the light source device does not control the luminances in consideration of a cause which would decrease luminance of light having entered a panel. That is, in the light source device disclosed in Patent Literature 2, no consideration is taken as to decrease in luminance in the panel, decrease in luminance due to a parallax barrier attached to the panel, and decrease in luminance due to other causes.

Consequently, the light source device disclosed in Patent Literature 2 suffers a problem that there is a possibility that images displayed in individual display regions have different luminances.

The present invention was made in view of the foregoing problem. An object of the present invention is to provide a display device capable of causing a plurality of images displayed in different display regions, respectively, to have substantially the same luminance.

### Solution to Problem

In order to solve the foregoing problem, a display device of the present invention includes: a display section having a plurality of display regions; a plurality of light sources for illuminating the respective plurality of display regions which are different from each other; either one or a plurality of sensors for measuring luminances of lights emitted from the plurality of display regions; and an operation section for carrying out, in accordance with a result measured by said either one or a plurality of sensors, at least one of (i) a process for decreasing a luminance of a light source of the plurality of light sources which illuminates a corresponding display region of the plurality of display regions from which light with higher luminance is emitted and (ii) a process for increasing a luminance of a light source of the plurality of light sources which illuminates a corresponding display region of the plurality of display regions from which light with lower luminance is emitted.

In order to solve the foregoing problem, a method of the present invention for controlling a display device is a method for controlling a display device which includes a display section having a plurality of display regions, and a plurality of light sources for illuminating the respective plurality of display regions which are different from each other; the method comprising the steps of: measuring luminances of lights emitted from the plurality of display regions by use of either one or a plurality of sensors; and carrying out, in accordance with a result measured by said either one or a plurality of sensors, at least one of (i) a process for decreasing a luminance of a light source of the plurality of light sources which illuminates a corresponding display region of the plurality of display regions from which light with higher luminance is emitted and (ii) a process for increasing a luminance of a light source of the plurality of light sources which illuminates a corresponding display region of the plurality of display regions from which light with lower luminance is emitted.

With the arrangement, in accordance with luminances of lights emitted from the plurality of display regions of the display section, which luminances are the result measured by said either one or a plurality of sensors, the operation section adjusts luminances of the plurality of light sources. With the arrangement, the adjustment is made by using lights emitted from the display section, so that adjustment of luminances of images respectively displayed in the display regions can be made in consideration of a cause which would decrease luminance of light having entered the display section (i.e. light having entered the panel).

Therefore, the above arrangement can cause luminances of images displayed in different display regions, respectively, to be substantially equal to each other. This ultimately allows a quality of an image to be adjusted under a circumstance similar to real conditions.

### Advantageous Effects of Invention

As described above, the display device of the present invention includes: a display section having a plurality of display regions; a plurality of light sources for illuminating the respective plurality of display regions which are different from each other; either one or a plurality of sensors for measuring luminances of lights emitted from the plurality of display regions; and an operation section for carrying out, in accordance with a result measured by said either one or a plurality of sensors, at least one of (i) a process for decreasing a luminance of a light source of the plurality of light sources which illuminates a corresponding display region of the plurality of display regions from which light with higher luminance is emitted and (ii) a process for increasing a luminance of a light source of the plurality of light sources which illuminates a corresponding display region of the plurality of display regions from which light with lower luminance is emitted.

As described above, the method of the present invention for controlling a display device is a method of controlling a display device which includes a display section having a plurality of display regions, and a plurality of light sources for illuminating the respective plurality of display regions which are different from each other;

the method comprising the steps of: measuring luminances of lights emitted from the plurality of display regions by use of either one or a plurality of sensors; and carrying out, in accordance with a result measured by said either one or a plurality of sensors, at least one of (i) a process for decreasing a luminance of a light source of the plurality of light sources which illuminates a corresponding display region of the plurality of display regions from which light with higher luminance is emitted and (ii) a process for increasing a luminance of a light source of the plurality of light sources which illuminates a corresponding display region of the plurality of display regions from which light with lower luminance is emitted.

Therefore, the present invention can yield an effect of causing luminances of images displayed in different display regions, respectively, to be substantially equal to each other.

### BRIEF DESCRIPTION OF DRAWINGS

FIG. 1 is a view schematically showing a configuration of a display device in accordance with one embodiment of the present invention.

FIG. 2 is a block diagram showing a configuration of an operation section and members related to the operation section in the display device shown in FIG. 1.

FIG. 3 is a view showing a configuration of a display device including one sensor.

FIG. 4 is a view showing an effect yielded by the display device shown in FIG. 1.

FIG. 5 is a view showing an advantage in arbitrarily adjusting luminances of images displayed in display regions, respectively, in the display device shown in FIG. 1.

FIG. 6 is a view showing an example in which the technique corresponding to FIGS. 1 and 2 is applied to a display device including no sensor.

(a) and (b) of FIG. 7 are perspective views each showing a configuration of a display device in accordance with another embodiment of the present invention.

FIG. 8 is a view schematically showing a configuration of the display device shown in (a) and (b) of FIG. 7, which configuration corresponds to the FIG. 1 configuration.

FIG. 9 is a view showing an embodiment of a backlight unit of the present invention.

FIG. 10 is a view showing an embodiment of a backlight unit of the present invention. (a) of FIG. 10 shows one configuration example of the backlight unit, and (b) of FIG. 10 shows another configuration example of the backlight unit.

FIG. 11 is a view showing still another configuration example of the backlight unit.

FIG. 12 is a view showing a relation between a viewing angle and luminance in DV (dual view) display.

(a) and (b) of FIG. 13 are image diagrams for explaining a function of a display device in accordance with still another embodiment of the present invention.

FIG. 14 is a view showing still another configuration example of the backlight unit.

### DESCRIPTION OF EMBODIMENTS

The following description will discuss embodiments of the present invention.

A display section 5 in accordance with the embodiments of the present invention which will be discussed below is a dual view display capable of displaying two images simultaneously or a quartet view display capable of displaying four images simultaneously.

Herein, in the display section 5 being a dual view display, display regions for displaying images are referred to as being at “A side” and “B side”, respectively, of the display section 5. In the display section 5 being a quartet view display, display regions for displaying images are referred to as being at “A side”, “B side”, “C side”, and “D side”, respectively, of the display section 5.

It should be noted that the display section 5 of the present invention is not limited to a dual view display or a quartet view display as long as the display section 5 can display a plurality of images simultaneously.

### Embodiment 1

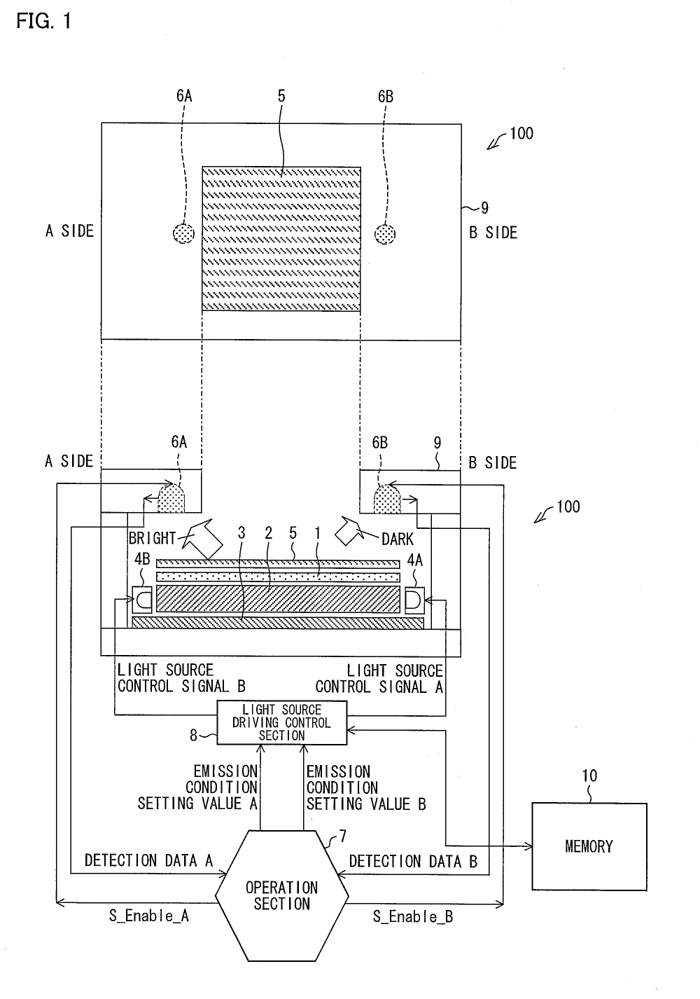

FIG. 1 is a view schematically showing a configuration of a display device 100 in accordance with Embodiment 1.

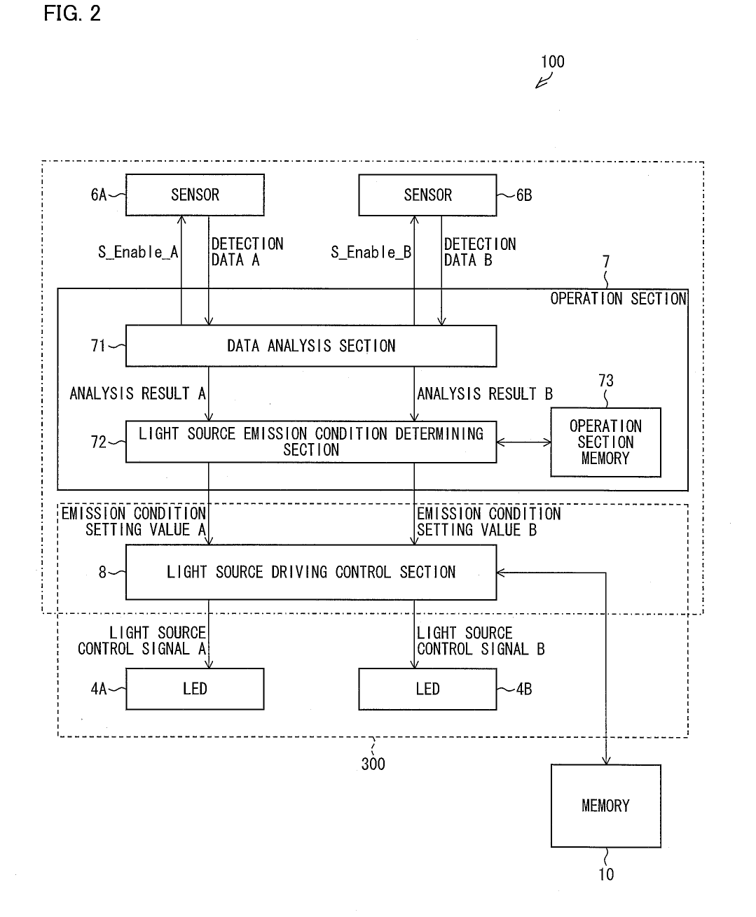

FIG. 2 is a block diagram showing a configuration of an operation section 7 and members involved in the operation section 7 in the display device 100.

The display device 100, shown in FIG. 1, includes a light path changing member 1, a light guide plate 2, a reflective sheet 3, LEDs 4A and 4B, the display section 5, sensors 6A and 6B, the operation section 7, a light source driving control section 8, a frame 9, and a memory 10. Note that the LEDs 4A and 4B and the light source driving control section 8, out of the constituents, are actually included in a backlight section 300 which illuminates the display section 5 from behind the display section 5.

“Front side” herein indicates a surface on a side on which the display section 5 displays an image (i.e. a side on which a user views the display section 5), and “back side” herein indicates a surface on a side opposite to the side on which the display section 5 displays an image.

It is assumed that the display section 5, shown in FIG. 1, is a dual view display.

The light path changing member 1 is provided behind the display section 5. The light guide plate 2 is provided behind the light path changing member 1. The reflective sheet 3 is provided behind the light guide plate 2. Furthermore, the LEDs 4A and 4B are provided at the lateral sides of the light guide plate 2.

The LEDs (light sources) 4A and 4B each serve as a light source for illuminating the display section 5 from behind the display section 5.

The LED 4A is provided so as to emit light to the light guide plate 2 from a B side. The LED 4B is positioned so as to emit light to the light guide plate 2 from an A side.

The light guide plate 2 is a plate which has been subjected to a concavities and convexities process, such as V-shaped grooves or dot-like openings. The light guide plate 2 diffuses lights received from the LEDs 4A and 4B, thereby emitting uniform light from a front side of the light guide plate 2, i.e. from a surface of the light guide plate 2 which surface is closer to the light path changing member 1.

The light guide plate 2 exits, from its front side, the light received from the LED 4A at an angle corresponding to a viewing angle of 70°±5° for example. On the other hand, the light guide plate 2 exits, from its front side, the light received from the LED 4B at an angle corresponding to a viewing angle of −70°±5° for example.

Herein, an angle at which a viewer views the display section 5 from a directly front direction is defined as a viewing angle 0°. A viewing angle inclined toward the A side with respect to the viewing angle 0° is defined as a positive (+) angle, whereas a viewing angle inclined toward the B side with respect to the viewing angle 0° is defined as a negative (−) angle.

The reflective sheet 3 is used to reflect a part of light emitted from the back side of the light guide plate 2 so that reflected light is converged onto the front side of the light guide plate 2.

Examples of the light path changing member 1 encompass an optical sheet, a diffusing sheet, and a prism sheet. The light path changing member 1 changes light paths of lights, received from the light guide plate 2, into desired light paths. The lights, whose paths have been changed, exit from the front side of the light path changing member 1, i.e. from a surface of the light path changing member 1 which surface is closer to the display section 5.

The light, which was emitted from the LED 4A and has entered the light path changing member 1 via the light guide plate 2, exits from the front side of the light path changing member 1 at an angle corresponding to a viewing angle of 45° for example. (The light, which was emitted from the LED 4B and has entered the light path changing member 1 via the light guide plate 2, exits from the front side of the light path changing member 1 at an angle corresponding to a viewing angle of −45° for example.

The display section 5 is a display panel capable of displaying a plurality of images simultaneously. Specifically, the display section 5 has a parallax barrier attached to the front side of the display section 5. The parallax barrier causes the display section 5 to divide a plurality of images into respective display regions. An example of the display section 5 is an LCD (Liquid Crystal Display).

The back side of the display region on the A side of the display section 5 is illuminated by light which is emitted from the LED 4A and exits from the light path changing member 1 via the light guide plate 2. Consequently, an image, displayed in the display region on the A side, has its peak in luminance at a viewing angle of 45°.

On the other hand, the back side of the display region on the B side of the display section 5 is illuminated by light which is emitted from the LED 4B and exits from the light path changing member 1 via the light guide plate 2. Consequently, an image, displayed in the display region on the B side, has its peak in luminance at a viewing angle of −45°.

With the configuration, the image displayed in the display region on the A side of the display section 5 and the image displayed in the display region on the B side of the display section 5 have their respective peaks in luminance in different directions.

According to the display device 100, viewing angles at which images displayed on the A and B sides of the display section 5 have their respective peaks in luminance can therefore be set to respective desired angles. As a result, the display device 100 can improve display qualities of the respective images.

Furthermore, according to the display device 100, it is unnecessary to increase intensity of light illuminating the display section 5 in a directly front direction of the display section 5 (at a viewing angle of 0°) in order that displayed images have their desired luminances in respective directions other than the directly front direction of the display section 5. This allows a reduction in power consumption.

The sensors 6A and 6B are provided on the front side of the display section 5, i.e. on a side of the display section 5 on which side the display section 5 displays an image. The sensors 6A and 6B are provided inside the frame 9 serving as a housing of the display device 100. Each of the sensors 6A and 6B is a luminance sensor which senses luminance of incident light.

The sensor 6A is provided on a path of light emitted from the display region on the A side of the display section 5. The sensor 6A measures luminance of incident light, and then supplies, as detection data A, a measured result to the operation section 7.

The sensor 6B is provided on a path of light emitted from the display region on the B side of the display section 5. The sensor 6B measures luminance of incident light, and then supplies, as detection data B, a measured result to the operation section 7.

As shown in FIG. 2, the operation section 7 includes a data analysis section 71, a light source emission condition determining section 72, and an operation section memory 73.

The following description will discuss a flow of operations of the operation section 7 and the members involved in the operation section 7.

Note that an example case will be described below in which an image displayed on the A side of the display section 5 is brighter than an image displayed on the B side of the display section 5.

The data analysis section 71 transmits a measurement instruction signal S_Enable_A to the sensor 6A. The data analysis section 71 transmits a measurement instruction signal S_Enable_B to the sensor 6B.

Upon receipt of the measurement instruction signal S_Enable_A, the sensor 6A starts measuring luminance, and then transmits, as detection data A, a measured result to the data analysis section 71. Upon receipt of the measurement instruction signal S_Enable_B, the sensor 6B starts measuring luminance, and then transmits, as detection data B, a measured result to the data analysis section 71.

The data analysis section 71 receives the detection data A and B. The data analysis section 71 carries out, to the detection data A, an AD (Analog-Digital) conversion and noise removal so as to obtain an analysis result A, and then transmits the analysis result A to the light source emission condition determining section 72. The data analysis section 71 carries out, to the detection data B, the AD conversion and the noise removal so as to obtain an analysis result B, and then transmits the analysis result B to the light source emission condition determining section 72.

Upon receipt of the analysis result A and the analysis result B, the light source emission condition determining section 72 compares a luminance measured by the sensor 6A which luminance is indicated by the analysis result A with a luminance measured by the sensor 6B which luminance is indicated by the analysis result B so as to determine which one of the luminances is larger/smaller than the other. In the present example, since the image displayed on the A side of the display section 5 is brighter than the image displayed on the B side of the display section 5, the luminance measured by the sensor 6A which luminance is indicated by the analysis result A is larger than the luminance measured by the sensor 6B which luminance is indicated by the analysis result B.

The operation section memory 73 is constituted by a ROM (Read Only Memory) for example. In the operation section memory 73, there is stored beforehand a lookup table indicative of a relation between compared results and an increase and decrease in current to be applied to the LED 4A and/or LED 4B.

The light source emission condition determining section 72 reads out the lookup table from the operation section memory 73.

The lookup table contains information that, in a case where the luminance indicated by the analysis result A is larger than the luminance indicated by the analysis result B, a current to be applied to the LED 4A is decreased by a predetermined amount. The lookup table contains information that, in a case where the luminance indicated by the analysis result A is smaller than the luminance indicated by the analysis result B, a current to be applied to the LED 4A is increased by a predetermined amount.

The light source emission condition determining section 72 transmits, to the light source driving control section 8, an emission condition setting value A which causes the current to be applied to the LED 4A to be decreased or increased by the predetermined amount in accordance with the information stored in the lookup table.

That is, in a case where the luminance indicated by the analysis result A is larger than the luminance indicated by the analysis result B, the emission condition setting value A indicates a value which causes the light source driving control section 8 to decrease the current to be applied to the LED 4A by the predetermined amount. On the other hand, in a case where the luminance indicated by the analysis result A is smaller than the luminance indicated by the analysis result B, the emission condition setting value A indicates a value which causes the light source driving control section 8 to increase the current to be applied to the LED 4A by the predetermined amount. In the present example, since the luminance indicated by the analysis result A is larger than the luminance indicated by the analysis result B, the emission condition setting value A indicates a value which causes the light source driving control section 8 to decrease the current to be applied to the LED 4A by the predetermined amount.

The lookup table may contain information that, in a case where the luminance indicated by the analysis result A is larger than the luminance indicated by the analysis result B, a current to be applied to the LED 4B is increased by a predetermined amount. Furthermore, the lookup table may contain information that, in a case where the luminance indicated by the analysis result A is smaller than the luminance indicated by the analysis result B, the current to be applied to the LED 4B is decreased by a predetermined amount. In this case, the light source emission condition determining section 72 transmits, to the light source driving control section 8, an emission condition setting value B which causes the current to be applied to the LED 4B to be increased or decreased in the same manner as a case of the emission condition setting value A which causes the current to be applied to the LED 4A to be increased or decreased.

The light source driving control section 8 receives the emission condition setting value A or the emission condition setting value B.

The light source driving control section 8 can be realized by, for example, a general LED driving circuit which drives the LED 4A and the LED 4B by applying currents to respective of the LED 4A and the LED 4B.

In accordance with the emission condition setting value A, the light source driving control section 8 can therefore easily generate the light source control signal A which is a current to be applied to the LED 4A. That is, in the present example, the light source driving control section 8 only needs to decrease a current of the light source control signal A in accordance with the emission condition setting value A.

Similarly, in accordance with the emission condition setting value B, the light source driving control section 8 can therefore easily generate the light source control signal B which is a current to be applied to the LED 4B. That is, in the present example, the light source driving control section 8 only needs to increase a current of the light source control signal B in accordance with the emission condition setting value B.

The above operation is repeated until a difference between the luminance indicated by the analysis result A and the luminance indicated by the analysis result B is less than a certain luminance (e.g. a luminance which is changed by increasing or decreasing a current to be applied to the LED 4A or LED 4B in one increasing or decreasing operation). The light source emission condition determining section 72 can determine, with reference to the analysis result A and the analysis result B, the difference between (i) the value of luminance indicated by the analysis result A (value of luminance measured by the sensor 6A) and (ii) the value of luminance indicated by the analysis result B (value of luminance measured by the sensor 6B).

Note that the light source driving control section 8 can have an alternative configuration which allows information to be read out from the memory 10 or information to be stored in the memory 10. This allows the light source driving control section 8 to (i) store in the memory 10 information indicative of a current to be applied to the LED 4A and/or 4B when the operation is completed, (ii) read out from the memory 10 a current of the light source control signal A in accordance with the emission condition setting value A, and (iii) read out from the memory 10 a current of the light source control signal B in accordance with the emission condition setting value B. The memory 10 can be provided in the backlight section 300 or in other component of the display device 100.

With the alternative configuration, in a case where luminance of an image displayed on the A side of the display section 5 and luminance of an image displayed on the B side of the display section 5 are different from each other due to individual difference between the LED 4A and the LED 4B, asymmetric visual properties of the display section 5, displacement of a parallax barrier etc., it is possible to make the different luminances substantially equal to each other. This ultimately allows a quality of an image to be adjusted under a circumstance similar to real conditions.

Examples of the LED 4A and the LED 4B encompass pseudo-white LEDs and LEDs with high color rendering property.

A CCFT (Cold Cathode Fluorescent Tube) can be employed, instead of each of the LED 4A and the LED 4B.

The description has dealt with the configuration in which the light source driving control section 8 carries out one of (i) the process (process A) for adjusting (increasing or decreasing), in accordance with the emission condition setting value A, a current (light source control signal A) to be applied to the LED 4A and (ii) the process (process B) for adjusting (increasing or decreasing), in accordance with the emission condition setting value B, a current (light source control signal B) to be applied to the LED 4B. Note, however, that the display device 100 of Embodiment 1 is not limited to this, and can be alternatively configured to carry out both of the processes A and B.

Specifically, in a case of the present example (in a case where an image displayed on the A side of the display section 5 is brighter than an image displayed on the B side of the display section 5), the light source driving control section 8 can (i) decrease a current of the light source control signal A in accordance with the emission condition setting value A (process A) and (ii) increase a current of the light source control signal B in accordance with the emission condition setting value B (process B).

The operation section 7 of the display device 100 carries out, in accordance with results of measurements by the sensors 6A and 6B, at least one of (i) a process for decreasing luminance of a light source which illuminates a display region from which light with higher luminance is emitted and (ii) a process for increasing luminance of a light source which illuminates a display region from which light with lower luminance is emitted. In the subsequent Embodiments, similar process(es) is carried out by the operation section 7.

### Embodiment 2

An RGB-LED of three LEDs, i.e. Red (R), Green (G), and Blue (B) LEDs can be employed as each of the LED 4A and the LED 4B.

In a case where an RGB-LED is employed as each of the LED 4A and the LED 4B, it is preferable that each of the sensors 6A and 6B is, instead of the luminance sensor, a color sensor which senses luminance and chromaticity of incident light.

The sensors 6A and 6B measure luminance and chromaticity, and transmit measured results to the operation section 7.

Operational flow of the operation section 7 and the members involved in the operation section 7 is the same as that in Embodiment 1 and therefore an explanation thereof is omitted here.

With reference to FIG. 1, the following description will discuss an operational flow, regarding chromaticity measured by the sensors 6A and 6B, of the operation section 7 and the members involved in the operation section 7.

Normally, chromaticity is expressed with the use of chromaticity coordinates (x, y). In a case where an RGB-LED is employed as the light source, emission of white light requires adjusting a ratio of currents to be applied to respective red, green, and blue LEDs. Chromaticity of white display is defined by chromaticity coordinates (0.3, 0.3), and currents to be applied to red, green, and blue LEDs are adjusted so that the chromaticity is obtained during the white display.

For example, in a case of causing chromaticity of the LED 4A emitting white light to match chromaticity of the LED 4B emitting white light, the sensor 6A measures chromaticity on the A side, and then chromaticity on the B side is changed to match the chromaticity on the A side. Conversely, the sensor 6B can measure the chromaticity on the B side, and then the chromaticity on the A side may be changed to match the chromaticity on the B side. Alternatively, the chromaticity of the LED 4A and/or the LED 4B can be changed to match predetermined target chromaticity (e.g. (0.3, 0.3)) during emission of white light.

In the operation section memory 73, there is stored beforehand a lookup table, regarding chromaticity, indicative of a relation between chromaticity coordinates and a current(s) to be applied to the LED 4A and/or LED 4B.

Specifically, the lookup table, regarding chromaticity, contains information that, in a case where chromaticity coordinates of chromaticity measured by the sensor 6A are different from chromaticity coordinates of chromaticity measured by the sensor 6B, a current to be applied to the LED 4A is changed by a predetermined amount so that the chromaticity coordinates of chromaticity measured by the sensor 6A match the chromaticity coordinates of chromaticity measured by the sensor 6B.

The light source emission condition determining section 72 transmits, to the light source driving control section 8, an emission condition setting value which causes a current to be applied to the LED 4A to be changed by the predetermined amount in accordance with the lookup table regarding chromaticity.

That is, in the case where chromaticity coordinates of chromaticity measured by the sensor 6A are different from chromaticity coordinates of chromaticity measured by the sensor 6B, the emission condition setting value indicates a value which causes the light source driving control section 8 to change a current to be applied to the LED 4A by the predetermined amount so that the chromaticity coordinates of chromaticity measured by the sensor 6A match the chromaticity coordinates of chromaticity measured by the sensor 6B.

The lookup table, regarding chromaticity, may contain information that, in the case where chromaticity coordinates of chromaticity measured by the sensor 6A are different from chromaticity coordinates of chromaticity measured by the sensor 6B, a current to be applied to the LED 4B is changed by a predetermined amount so that the chromaticity coordinates of chromaticity measured by the sensor 6A match the chromaticity coordinates of chromaticity measured by the sensor 6B. In a case where the lookup table, regarding chromaticity, contains such information, the operation section 7 transmits, to the light source driving control section 8, an emission condition setting value which causes the current to be supplied to the LED 4B to be changed in the same manner as a case of the emission condition setting value which causes the current to be supplied to the LED 4A to be changed.

In accordance with the emission condition setting value, the light source driving control section 8 generates a current(s) to be applied to the LED 4A and/or LED 4B, and applies the current(s) to the LED 4A and/or LED 4B, thereby driving the LED 4A and/or LED 4B.

The above operation is repeated until the chromaticity coordinates measured by the sensor 6A are equal to the chromaticity coordinates measured by the sensor 6B (e.g. chromaticity coordinates (x, y)=(0.3, 0.3)).

With the configuration, in addition to the foregoing effect of Embodiment 1, it is possible to make, substantially equal, (i) chromaticity of an image displayed on the A side of the display section 5 and (ii) chromaticity of an image displayed on the B side of the display section 5 which chromaticity is different from that of the image displayed on the A side. This ultimately allows color of an image to be adjusted under a circumstance similar to real conditions.

### Embodiment 3

According to Embodiments 1 and 2, two sensors, the sensors 6A and 6B, are employed as a sensor for measuring luminance (and chromaticity if necessary) of incident light on the front side of the display section 5, i.e. on a side on which the display section 5 displays an image.

However, the number of the sensors is not particularly limited. For example, the display device 100 can include three or more of the sensors.

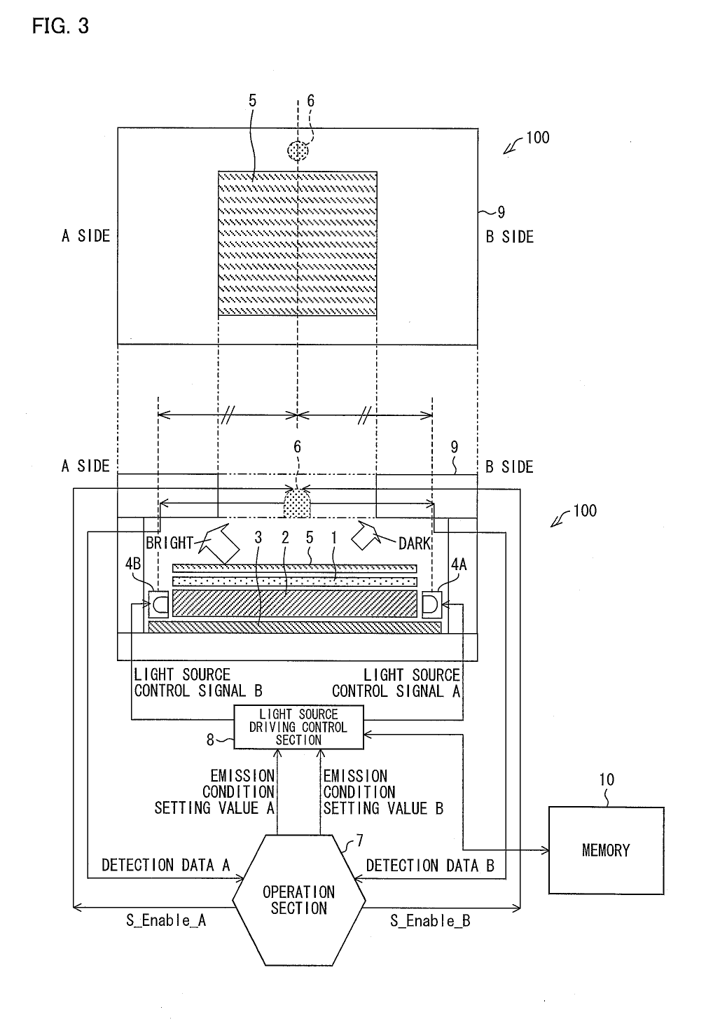

Alternatively, the display device 100 can include one such sensor. An example of this arrangement is shown in FIG. 3.

The display device 100, shown in FIG. 3, includes one sensor 6 instead of the sensors 6A and 6B.

The sensor 6 is provided on the front side of the display section 5 and inside the frame 9. For convenience, in the cross sectional view of FIG. 3, the sensor 6 is provided inside the frame 9 which is defined by chain double-dashed lines, which frame 9 is provided on an upper side of the plan view of FIG. 3.

Note that a configuration is preferable in which the sensor 6 is provided such that a distance between the sensor 6 and the LED 4A is equal to a distance between the sensor 6 and the LED 4B. This is because such a configuration allows for measurements, under the same conditions possible, of (i) light emitted from the display region on the A side of the display section 5 and (ii) light emitted from the display region on the B side of the display section 5.

Assume that lights are emitted from both of the A side and B side of the display section 5 in the case where the sensor 6 measures luminance (and chromaticity if necessary). In such a case, it will be difficult to distinguish light coming from the display region on the A side from light coming from the display region on the B side.

In view of the circumstances, in the case where one sensor 6 measures lights coming from the display regions on the respective A and B sides of the display section 5 as shown in FIG. 3, there are secured (i) a time period during which light is measured while only the LED 4A is emitting light and (ii) a time period during which light is measured while only the LED 4B is emitting light.

Specifically, the LED 4A is caused to emit light while the LED 4B is in a turn-off state, and then a result measured by the sensor 6 is regarded as a result obtained by measuring light emitted from the display region on the A side (corresponding to detection data A). Subsequently, the LED 4B is caused to emit light while the LED 4A is in a turn-off state, and then a result measured by the sensor 6 is regarded as a result obtained by measuring light emitted from the display region on the B side (corresponding to detection data B).

This allows the sensor 6 to serve as both of the sensors 6A and 6B. Accordingly, it is possible to cause the operation section 7 and members involved in the operation section 7 to operate easily based on the configuration of the block diagram of FIG. 2 and the description thereof.

The description has dealt with a case where the sensor 6 is a luminance sensor. Note, however, that Embodiment 3 is not limited to such. Alternatively, the sensor 6 can be a color sensor.

In a case where the display device 100 includes a plurality of sensors, e.g. the sensor 6A and the sensor 6B as shown in FIG. 1, it is preferable that the number of the sensors provided on the A side is equal to the number of the sensors provided on the B side. This is because by providing the A side and the B side with the same number of sensors, it is possible to measure, under the same conditions possible, (i) light emitted from the display region on the A side and (ii) light emitted from the display region on the B side.

Furthermore, by providing the sensor 6 or the sensors 6A and 6B inside the frame 9, the influence of provision of the sensor on the appearance design of the end product of the display device 100 can be as small as possible.

[Effects Brought about by Embodiments 1-3]

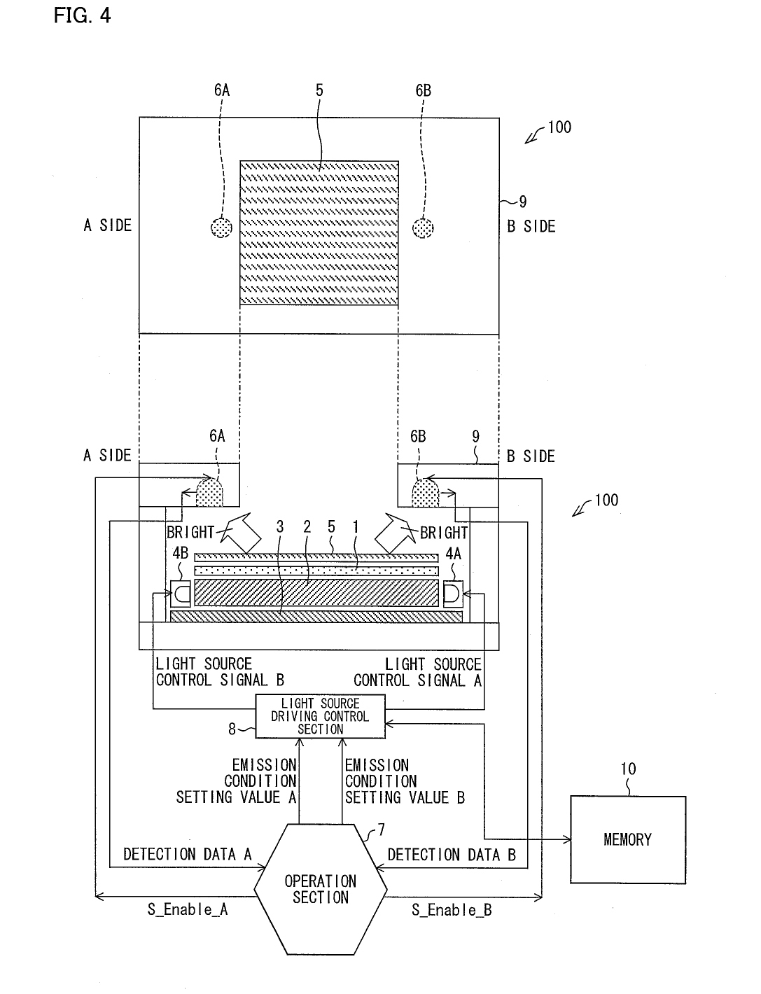

In a case where a pseudo-white LED or LED with high color rendering properties is employed as each of the LEDs 4A and 4B, it is preferable that the display device 100 is arranged in accordance with Embodiment 1. This allows luminance of an image displayed on the A side of the display section 5 to be equal to luminance of an image displayed on the B side of the display section 5 (see FIG. 4).

FIG. 4 shows an example in which (i) luminance of an image displayed on the A side of the display section 5 and (ii) luminance of an image displayed on the B side of the display section 5, are both made higher and equal. Contrast of the luminances thus made equal can be determined appropriately by increasing or decreasing a current to be applied to the LED 4A or LED 4B in the FIG. 2 configuration.

In a case where an RGB-LED is employed as each of the LEDs 4A and 4B, it is preferable that the display device 100 is configured in accordance with Embodiment 2. This allows luminance of an image displayed on the A side of the display section 5 to be equal to luminance of an image displayed on the B side of the display section 5. This further allows chromaticity (color) of an image displayed on the A side of the display section 5 to be equal to chromaticity (color) of an image displayed on the B side of the display section 5 (see FIG. 4).

Consequently, the display device 100 can reduce a difference in display quality (appearance) between images displayed on the display section 5.

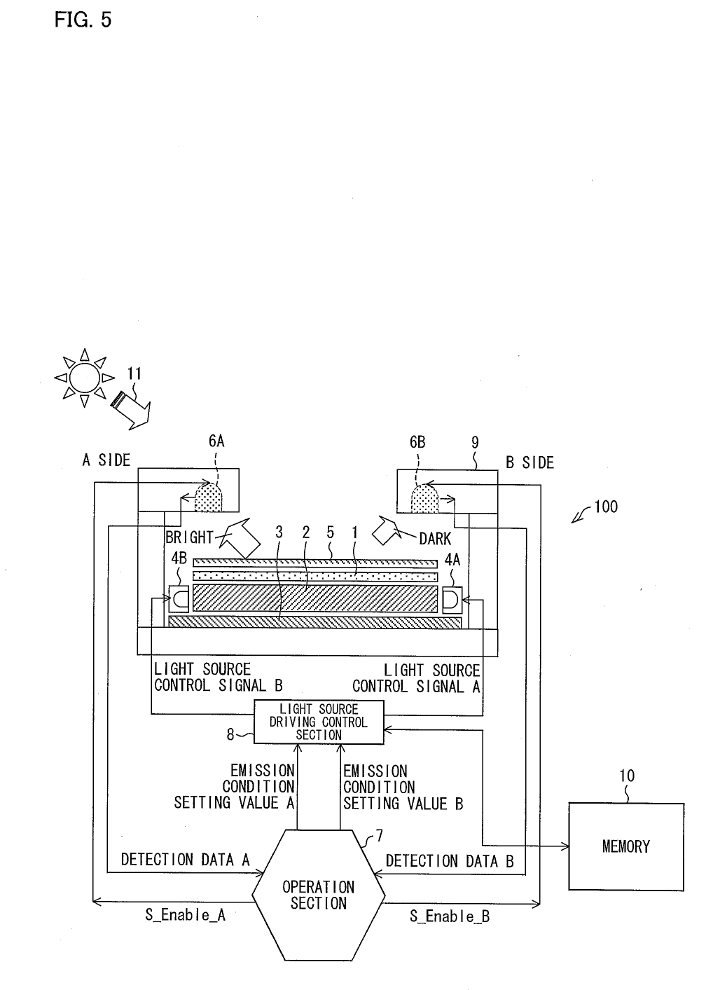

Furthermore, the display device 100 can set luminance (and chromaticity) of an image displayed on the A side and/or B side of the display section 5 to any luminance (chromaticity coordinates). A suitable case for this configuration will be described below with reference to FIG. 5.

In FIG. 5, a display device 100 receives external lights 11 in a display region on the A side of the display section 5. In a case where the external light 11 has high intensity, a display quality of the display device 100 will be reduced greatly. In this case, however, the display quality will be improved by increasing luminance of a backlight. That is, in this case, it is necessary to increase luminance of light emitted from a corresponding LED. Specifically, light emitted from an LED 4A is required to have higher luminance than that of light emitted from an LED 4B.

In this case, while the display is in a turn-off state (backlight is turned off), sensors 6A and 6B sense luminances of the external light. Based on sensed data, it is analyzed which of the external light sensed by the sensor 6A and the external light sensed by the sensor 6B has higher luminance. In order to increase a display quality on a side where the external light has higher luminance (e.g. side A in FIG. 5), the light source emission condition determining section 72 increases a current to be applied to the LED 4A while the display is in a turn-on state (backlight is turned on). The lookup table contains information that currents to be applied to the LEDs 4A and 4B are changed by a predetermined amount in accordance with luminances of the external lights which have been measured by the respective sensors.

### Embodiment 4

Driving control of the LEDs 4A and 4B in accordance with Embodiments 1 through 3 is a current control in which amplitudes of currents to be applied to the respective LEDs 4A and 4B are variable.

Another examples of driving control of LEDs encompass PWM (Pulse Width Modulation) in which a pulse width of a current to be supplied to each of the LEDs 4A and 4B is variable.

Also in a case where driving control of the LEDs 4A and 4B is PWM, a display device 100 can bring about effects similar to those brought about by Embodiments 1 through 3. In Embodiment 4, such a display device 100 will be described below.

The display device 100 in accordance with Embodiment 4 has schematically the same configuration as the display device 100 having the FIG. 1 configuration or the FIG. 2 configuration. Accordingly, as for operational flow of the operation section 7 and members involved in the operation section 7, only a difference from the operational flow in Embodiment 1 will be described.

In the operation section memory 73, there is stored beforehand a lookup table indicative of a relation between (i) results obtained by comparing between a luminance indicated by an analysis result A and a luminance indicated by an analysis result B so as to determine which one of the luminances is larger/smaller than the other and (ii) a change in duty ratio, during one cycle, of a current(s) to be applied to the LED 4A and/or LED 4B.

The light source emission condition determining section 72 reads out the lookup table from the operation section memory 73.

The lookup table contains information that, in a case where the luminance indicated by the analysis result A is larger than the luminance indicated by the analysis result B, a duty ratio of a current to be applied to the LED 4A is decreased by a predetermined ratio. The lookup table further contains information that, in a case where the luminance indicated by the analysis result A is smaller than the luminance indicated by the analysis result B, the duty ratio of a current to be applied to the LED 4A is increased by a predetermined ratio.

The light source emission condition determining section 72 transmits, to the light source driving control section 8, an emission condition setting value A which causes the duty ratio, of a current to be applied to the LED 4A, to be changed by the predetermined ratio in accordance with the information contained in the lookup table.

That is, in a case where the luminance indicated by the analysis result A is larger than the luminance indicated by the analysis result B, the emission condition setting value A indicates a value which causes the light source driving control section 8 to decrease the duty ratio of a current to be applied to the LED 4A by a predetermined ratio. On the other hand, in a case where the luminance indicated by the analysis result A is smaller than the luminance indicated by the analysis result B, the emission condition setting value A indicates a value which causes the light source driving control section 8 to increase the duty ratio of a current to be applied to the LED 4A by a predetermined ratio.

The lookup table may contain information that, in the case where the luminance indicated by the analysis result A is larger than the luminance indicated by the analysis result B, a duty ratio of a current to be applied to the LED 4B is increased by a predetermined ratio. Furthermore, the lookup table may contain information that, in the case where the luminance indicated by the analysis result A is smaller than the luminance indicated by the analysis result B, the duty ratio of a current to be applied to the LED 4B is decreased by a predetermined ratio. In this case, the light source emission condition determining section 72 transmits, to the light source driving control section 8, an emission condition setting value B which causes the duty ratio of a current to be applied to the LED 4B to be changed in the same manner as a case of the emission condition setting value A which causes the duty ratio of a current to be applied to the LED 4A to be changed.

The light source driving control section 8 receives, from the light source emission condition determining section 72, the emission condition setting value A or the emission condition setting value B.

The light source driving control section 8 can be realized, for example, by a general LED driving circuit which drives the LEDs 4A and 4B by applying, to the LEDs 4A and 4B, currents which have been subjected to PWM.

In accordance with the emission condition setting value A, the light source driving control section 8 can thus easily generate the light source control signal A which is a current to be applied to the LED 4A. That is, the light source driving control section 8 only needs to change the duty ratio of a current of the light source control signal A in accordance with the emission condition setting value A.

Similarly, in accordance with the emission condition setting value B, the light source driving control section 8 can easily generate the light source control signal B which is a current to be applied to the LED 4B. That is, the light source driving control section 8 only needs to change the duty ratio of a current of the light source control signal B in accordance with the emission condition setting value B.

The above operation is repeated until a difference between the luminance indicated by the analysis result A and the luminance indicated by the analysis result B is less than a certain luminance (e.g. a luminance corresponding to a duty ratio of a current which can be changed in one operation). The light source emission condition determining section 72 can determine, with reference to the analysis result A and the analysis result B, the difference between (i) the value of luminance indicated by the analysis result A (value of luminance measured by the sensor 6A) and (ii) the value of luminance indicated by the analysis result B (value of luminance measured by the sensor 6B).

Other configurations and operations of the display device 100 configured as above are the same as those of the display device 100 in accordance with Embodiment 1.

With the configuration, in a case where luminance of an image displayed on the A side of the display section 5 and luminance of an image displayed on the B side of the display section 5 are different from each other due to individual difference between the LED 4A and the LED 4B, asymmetric visual properties of the display section 5, displacement of a parallax barrier etc., it is possible to make the different luminances substantially equal to each other. That is, also in the case where the driving control of the LEDs 4A and 4B is made based on PWM, the display device 100 can yield effects similar to those yielded by Embodiments 1 to 3.

Furthermore, also in the case where the driving control of the LEDs 4A and 4B is made based on PWM, by employing RGB-LEDs as the LEDs 4A and 4B and color sensors as the sensors 6A and 6B, it is possible to make, substantially equal, (i) chromaticity of an image displayed on the A side of the display section 5 and (ii) chromaticity of an image displayed on the B side of the display section 5 which chromaticity is different from that of an image displayed on the A side.

In the operation section memory 73, there is stored beforehand a lookup table indicative of a relation between chromaticity coordinates and a duty ratio of a current to be applied to the LED 4A and/or LED 4B.

That is, the lookup table regarding chromaticity contains information that, in a case where chromaticity coordinates of chromaticity measured by the sensor 6A are different from chromaticity coordinates of chromaticity measured by the sensor 6B, a duty ratio of a current to be applied to the LED 4A is changed by a predetermined ratio so that the chromaticity coordinates of chromaticity measured by the sensor 6A are equal to the chromaticity coordinates of chromaticity measured by the sensor 6B.

The light source emission condition determining section 72 transmits, to the light source driving control section 8, an emission condition setting value which causes the duty ratio of a current to be applied to the LED 4A to be changed by a predetermined value in accordance with the lookup table regarding chromaticity.

That is, in the case where chromaticity coordinates of chromaticity measured by the sensor 6A are different from chromaticity coordinates of chromaticity measured by the sensor 6B, the emission condition setting value indicates a value which causes the light source driving control section 8 to change the duty ratio of a current to be applied to the LED 4A by the predetermined ratio so that the chromaticity coordinates of chromaticity measured by the sensor 6A are equal to the chromaticity coordinates of chromaticity measured by the sensor 6B.

The lookup table regarding chromaticity may contain information that, in a case where chromaticity coordinates of chromaticity measured by the sensor 6A are different from chromaticity coordinates of chromaticity measured by the sensor 6B, a duty ratio of a current to be applied to the LED 4B is changed by a predetermined ratio so that the chromaticity coordinates of chromaticity measured by the sensor 6A are equal to the chromaticity coordinates of chromaticity measured by the sensor 6B. In this case, the operation section 7 transmits, to the light source driving control section 8, an emission condition setting value which causes the duty ratio of a current to be applied to the LED 4 B to be changed in the same manner as a case of the emission condition setting value which causes the duty ratio of a current to be applied to the LED 4A to be changed.

In accordance with the emission condition setting value, the light source driving control section 8 generates a current(s) to be applied to the LED 4A and/or the LED 4B, and applies the current(s) to the LED 4A and/or the LED 4B, thereby driving the LED 4A and/or the LED 4B.

The above operation is repeated until the chromaticity coordinates measured by the sensor 6A are equal to the chromaticity coordinates measured by the sensor 6B (e.g. chromaticity coordinates (x, y)=(0.3, 0.3)).

Other configurations and operations of the display device 100 configured as above are the same as those of the display device 100 in accordance with Embodiment 2.

Note that the technique in accordance with Embodiment 4 can be combined with the technique in accordance with Embodiment illustrated in FIG. 3. Specifically, by using one sensor 6 instead of the sensors 6A and 6B, luminance (and chromaticity if necessary) can be measured as described above regarding the sensor 6.

In the above arrangement, the light source driving control section 8 carries out one of the process (process A) for adjusting (increasing or decreasing), in accordance with the emission condition setting value A, the duty ratio of a current (light source control signal A) to be applied to the LED 4A, and the process (process B) for adjusting (increasing or decreasing), in accordance with the emission condition setting value B, the duty ratio of a current (light source control signal B) to be applied to the LED 4B. Note, however, that the display device 100 of the present embodiment is not limited to this, and can be alternatively configured to carry out both of the processes A and B.

The display device 100 of the present embodiment may be configured such that, in a case of the present example (in a case where an image displayed on the A side of the display section 5 is brighter than an image displayed on the B side of the display section 5), the light source driving control section 8 decreases the duty ratio of the light source control signal A in accordance with the emission condition setting value A (process A), and increases the duty ratio of the light source control signal B in accordance with the emission condition setting value B (process B).

As described above, the operation section 7 of the display device 100 carries out, in accordance with the results of measurements by the sensors 6A and 6B, at least one of (i) a process for decreasing luminance of a light source which illuminates a display region from which light with higher luminance is emitted and (ii) a process for increasing luminance of a light source which illuminates a display region from which light with lower luminance is emitted. In the subsequent Embodiments, similar process(es) is carried out by the operation section 7.

The configurations of the present embodiment yield effects similar to those yielded by Embodiments 1 to 3.

### Embodiment 5

It is also possible to carry out the techniques equivalent to each of Embodiments 1 through 4, even in a case where a display device 100 does not include a luminance sensor or a color sensor which is represented by the sensors 6A and 6B and the sensor 6, that is, even in a case where the display device 100, serving as an end product, does not include a sensor. The following description will discuss a specific example in which the technique equivalent to Embodiment 1 is carried out and the display device 100 includes no sensor.

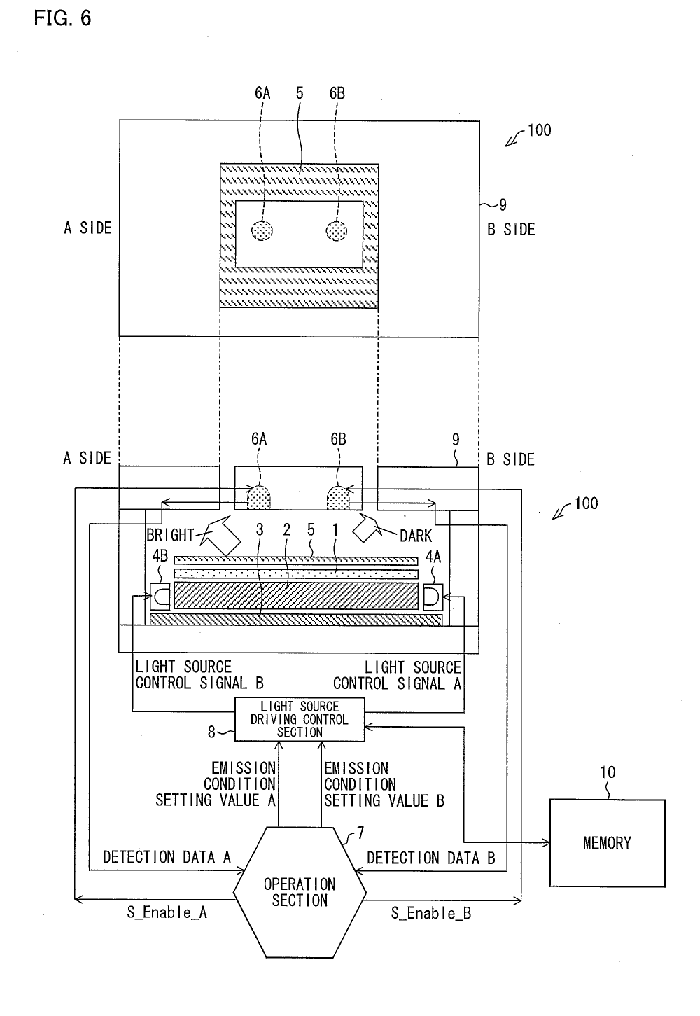

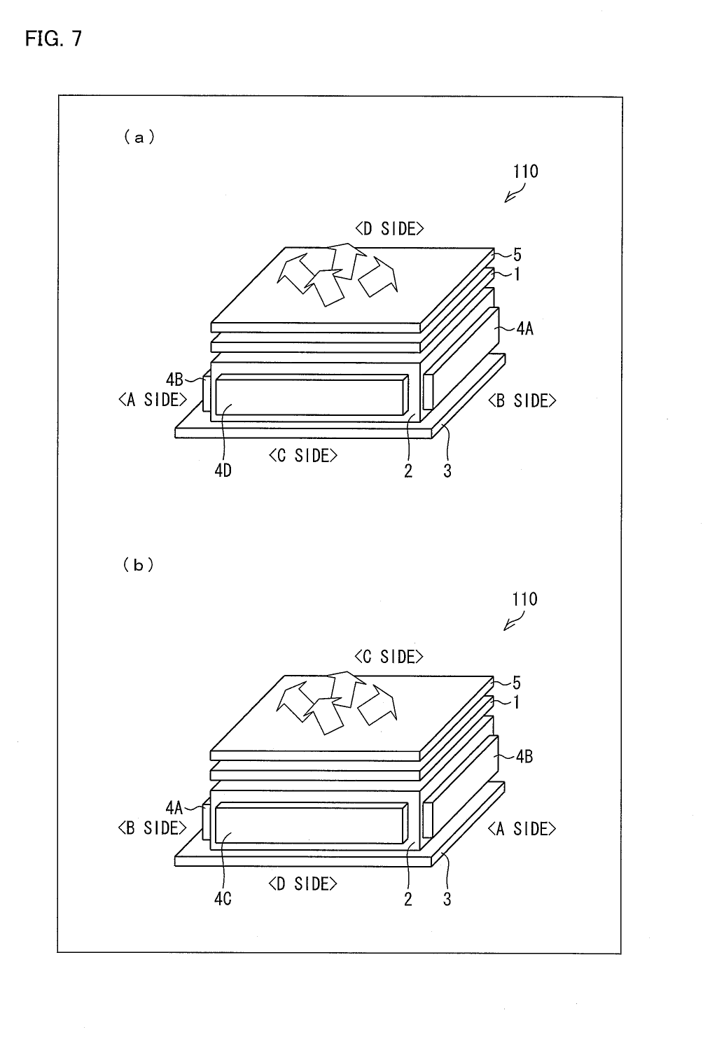

FIG. 6 shows a configuration of the display device 100 in accordance with Embodiment 5.

The sensor 6A, shown in FIG. 6, is provided on a path of light emitted from the display region on the A side of a display section 5. The sensor 6B, shown in FIG. 6, is provided on a path of light emitted from the display region on the B side of the display section 5. The sensors 6A and 6B, shown in FIG. 6, are different from those shown in FIG. 1 in that the sensors 6A and 6B, shown in FIG. 6, are not provided in the display device 100. It should be noted, however, that the sensors 6A and 6B, shown in FIG. 6, have the same functions as those of the sensors 6A and 6B shown in FIG. 1.

A member, in which the sensors 6A and 6B are provided, is not particularly limited, provided that the member is not the display device 100. Accordingly, for convenience, the member, supporting the sensors 6A and 6B, is not shown in detail in FIG. 6.

For example, according to Embodiment 5 shown in FIG. 6, as in the case of configurations shown in FIG. 1 and FIG. 2, the sensors 6A and 6B measure luminances before shipping of, for example, the display device 100 and then transmit respective detection data A and B to the data analysis section 71.

The data analysis section 71, the light source emission condition determining section 72, and the operation section memory 73 have the same configurations and operations as those shown in FIG. 2 and therefore detailed explanations thereof are omitted here.

As of a time point when the light source driving control section 8 causes images, displayed on the respective A and B sides of the display section 5, to have substantially identical luminances (i.e., as of a time point when adjustments of luminances of the respective LEDs 4A and 4B are completed), the light source driving control section 8 stores, in the memory 10, emission condition setting values A and B which the light source driving control section 8 has received last.

Thereafter, in a case where emission of the LEDs 4A and 4B is required in the display device 100, the light source driving control section 8 reads out the emission condition setting values A and B from the memory 10, and then sets luminances of the respective LEDs 4A and 4B in accordance with the respective emission condition setting values A and B.

With the configuration, it is possible to carry out the technique equivalent to Embodiment 1, even in a case where the display device 100 includes no sensor.

The technique in accordance with Embodiment 5 can be expressed as follows.

A method for controlling the display device 100 which includes the display section 5 having a plurality of display regions and the LEDs 4A and 4B for illuminating the display section 5 from the back side thereof so as to illuminate the respective plurality of display regions which are different from each other, the method including the steps of: measuring luminances of lights emitted from the plurality of display regions by use of the sensors 6A and 6B, and, in accordance with a result measured by the sensors 6A and 6B, decreasing luminance of the LED 4A or the LED 4B which illuminates a display region from which light with higher luminance is emitted, or increasing luminance of the LED 4A or the LED 4B which illuminates a display region from which light with lower luminance is emitted.

Also in cases of other embodiments, the light source driving control section 8 may be arranged to operate in such a manner that the light source driving control section 8 stores in the memory 10 emission condition setting values A and B which the light source driving control section 8 has received last, and when emission of the LEDs 4A and 4B is required, the light source driving control section 8 reads out the emission condition setting values A and B from the memory 10, and then sets luminances of the respective LEDs 4A and 4B in accordance with the respective emission condition setting values A and B. Thus, also in the cases of other embodiments, it is possible to carry out the technique corresponding to any of those other embodiments while the display device 100 includes no sensor.

### Embodiment 6

(a) and (b) of FIG. 7 are perspective views each showing a configuration of a display device 110 in accordance with Embodiment 6. (a) of FIG. 7 is a view showing the display device 110 viewed from a C side. (b) of FIG. 7 is a view showing the display device 110 viewed from a D side.

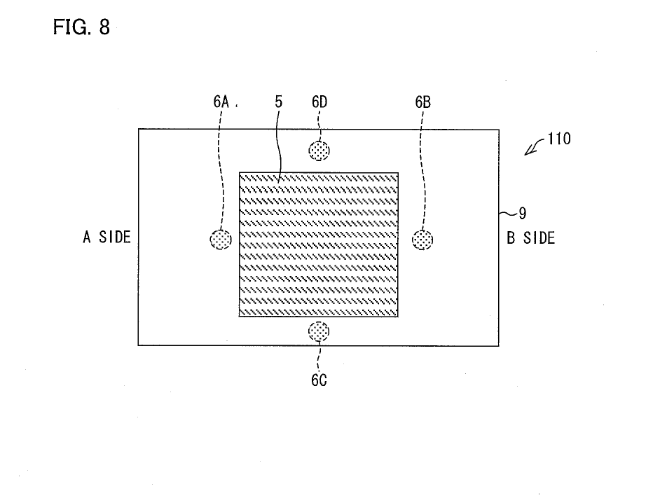

FIG. 8 is a view schematically showing a configuration of the display device 110 in accordance with Embodiment 6, which configuration corresponds to the configuration shown in FIG. 1. For convenience, FIG. 8 only shows a plan view of the display device 110 which corresponds to the configuration shown in FIG. 1.

The display section 5 of the display device 100 in accordance with each of Embodiments 1 through 5 is a dual view display.

On the other hand, a display section 5 of the display device 110 in accordance with Embodiment 6 is a quartet view display.

This causes the display device 110 to include not only the configuration of the display device 100 shown in FIG. 1 but also LEDs 4C and 4D and sensors 6C and 6D. Out of them, the LEDs 4C and 4D are actually included in a backlight section 300.

As in the case of the LEDs 4A and 4B, the LEDs (light sources) 4C and 4D are light sources which are provided at lateral sides of a light guide plate 2 and which illuminate the display section 5 from a back side of the display section 5.

The LED 4C is provided so as to emit light to the light guide plate 2 from a D side. The LED 4D is provided so as to emit light to the light guide plate 2 from a C side.

A straight line by which the LEDs 4A and 4B are connected is orthogonal to a straight line by which the LEDs 4C and 4D are connected. A positional relationship between the LEDs 4C and 4D is identical to the positional relationship between the LEDs 4A and 4B.

The light path changing member 1, the light guide plate 2, and the reflective sheet 3 act on light emitted from the LEDs 4C and 4D in the same manner as on light emitted from the LEDs 4A and 4B.

Herein, an angle at which a viewer views the display section 5 from a directly front direction is defined as a viewing angle 0°. A viewing angle inclined toward the C side with respect to the viewing angle 0° is defined as a positive (+) angle, whereas a viewing angle inclined toward the D side with respect to the viewing angle 0° is defined as a negative (−) angle. Note, however, that the viewing angle inclined toward the C side or the D side is indicated by use of square brackets [ ]. This is because it is necessary to distinguish (i) between a viewing angle inclined toward the A side and a viewing angle inclined toward the C side and (ii) between a viewing angle inclined toward the B side and a viewing angle inclined toward the D side.

The light which was emitted from the LED 4C and has entered the light path changing member 1 via the light guide plate 2 exits from a front side of the light path changing member 1, for example, at an angle corresponding to a viewing angle [45°]. The light which was emitted from the LED 4D and has entered the light path changing member 1 via the light guide plate 2 exits from a front side of the light path changing member 1, for example, at an angle corresponding to a viewing angle [−45°].

The back side of the display region on the C side of the display section 5 is illuminated by light which is emitted from the LED 4C and exits from the light path changing member 1 via the light guide plate 2. Consequently, an image, displayed in the display region on the C side, has its peak in luminance at a viewing angle [45°].

On the other hand, the back side of the display region on the D side of the display section 5 is illuminated by light which is emitted from the LED 4D and exits from the light path changing member 1 via the light guide plate 2. Consequently, an image, displayed in the display region on the D side, has its peak in luminance at a viewing angle [−45°].

With the above configuration, an image displayed on the A side of the display section 5, an image displayed on the B side of the display section 5, an image displayed on the C side of the display section 5, and an image displayed on the D side of the display section 5 have their respective peaks in luminance in different directions.

According to the display device 110, viewing angles at which images displayed on the A to D sides of the display section 5 have their respective peaks in luminance can therefore be set to desired angles. As a result, the display device 110 can improve display qualities of the respective images.

Furthermore, according to the display device 110, it is unnecessary to increase intensity of light illuminating the display section 5 in a directly front direction of the display section 5 (at viewing angles of 0° and [0°]) in order that displayed images have their desired luminances in respective directions other than the directly front direction of the display section 5. This allows a reduction in power consumption.

The sensors 6C and 6D are provided on the front side of the display section 5, i.e. on a side of the display section 5 on which side the display section 5 displays an image. The sensors 6C and 6D are provided inside the frame 9 serving as a housing of the display device 110. Each of the sensors 6C and 6D is a luminance sensor which senses luminance of incident light.

The sensor 6C is provided on a path of light emitted from the display region on the C side of the display section 5. The sensor 6C measures luminance of incident light, and then supplies, to the operation section 7, a measured result as detection data C which is different from detection data A and B.

The sensor 6D is provided on a path of light emitted from the display region on the D side of the display section 5. The sensor 6D measures luminance of incident light, and then supplies, to the operation section 7, a measured result as detection data D which is different from detection data A to C.

As is clear from above, the LEDs 4C and 4D and the sensors 6C and 6D correspond to (i) the LEDs 4A and 4B and (ii) the sensors 6A and 6B, respectively. The LEDs 4C and 4D have configurations similar to those of the LEDs 4A and 4B, and the sensors 6C and 6D have configurations similar to those of the sensors 6A and 6B.

In other words, the display device 110 includes the display device 100 having a cross section shown in FIG. 1. Furthermore, the display device 110 has cross sections on the C and D sides which cross sections are similar to the cross section in FIG. 1 and include (i) the LEDs 4C and 4D and (ii) the sensors 6C and 6D, respectively.

Furthermore, the operation section 7 of the display device 110 has two configurations of the operation section 7 shown in FIG. 2. Specifically, the operation section 7 of the display device 110 has (i) a configuration, shown in FIG. 2, for adjusting luminances of the LEDs 4A and 4B and (ii) a configuration, shown in FIG. 2, for adjusting luminances of the LEDs 4C and 4D. Since these two configurations each cause corresponding two LEDs to operate and function in a similar manner, detailed descriptions of their respective operations and functions are omitted here.

With the configuration, in a case where luminance of an image displayed on the C side of the display section 5 and luminance of an image displayed on the D side of the display section 5 are different from each other due to individual difference between the LED 4C and the LED 4D, asymmetric visual properties of the display section 5, displacement of a parallax barrier etc., it is possible to make the different luminances substantially equal to each other.

The configuration for adjusting luminances of the LEDs 4C and 4D can be combined with the techniques in accordance with each of Embodiments 1 through 5 which are applied to the configuration for adjusting luminances of the LEDs 4A and 4B.

That is, each of the sensors 6A to 6D may be a color sensor instead of a luminance sensor. Control of emission of the LEDs 4C and 4D may be a current control or a PWM control. The number of sensors may be five or more, or three or more. The present invention may be arranged such that the display device 110 as an end product does not include a sensor and luminance is adjusted by using a sensor at the time of pre-shipment check etc. The present invention encompasses not only a case where values of luminances on the A to D sides are made equal to each other but also a case where a value of each luminance (and chromaticity if necessary) is set to any value.

### Embodiment 7

According to Embodiments 1 through 6, luminance (and chromaticity if necessary) of an LED serving as a light source is adjusted by measuring the luminance (and the chromaticity if necessary).

In Embodiment 7, a case where an image sensor is used as a sensor will be described below.

A dual view display divides images in two directions by using a parallax barrier attached to the display section 5. Displaced attachment of the parallax barrier to the display section 5 may result in difference in area capable of transmitting light between the A side and the B side of the display section 5, causing a difference in luminance therebetween.

According to Embodiment 7, in a case where an image displayed on the A side of the display section 5 and an image displayed on the B side of the display section 5 have different luminances due to displaced attachment of the parallax barrier to the display section 5, the different luminances are made substantially equal.

The display device 100 in accordance with Embodiment 7 is equal to the configuration in which an image sensor is employed as the sensor 6 shown in FIG. 3.

The sensor 6 measures how much displaced the attachment of the parallax barrier to the display section 5 is. In accordance with the measured displacement, the operation section 7 calculates areas capable of transmitting light on the respective A and B sides of the display section 5. In accordance with the areas calculated by the operation section 7, the light source driving control section 8 calculates currents (or duty ratios of currents) to be applied to the LEDs 4A and 4B, and adjusts luminances of the LEDs 4A and 4B in accordance with the respective calculated currents.

(a) and (b) of FIG. 13 are image diagrams for explaining a function of the display device 100 in accordance with Embodiment 7.

The following description will discuss an example in which displaced attachment occurs in a case where the parallax barrier 130 is attached to the display section 5 such that a center 131c of an opening 131 of the parallax barrier 130 is brought into line with a center 134c of a BM (black matrix) between pixel sections 133 of the display section 5. (a) of FIG. 13 shows a case where there is no displacement, and (b) of FIG. 13 shows a case where there is displacement. The image sensor 135 measures (i) a distance between the center 134c of the BM 134 and an end on an A side of the opening 131 and (ii) a distance between the center 134c and an end on a B side of the opening 131. The image sensor 135 can measure, based on the distances thus calculated, how much displaced the attachment of the parallax barrier 130 to the display section 5 is.

In accordance with the displacement measured by the image sensor 135, the light source emission condition determining section 72 of the operation section 7 calculates sizes (or ratio) of areas capable of transmitting light in the display regions on the respective A and B sides. For example, in a case of (b) of FIG. 13, the distance between the center 134c and the end on the A side of the opening 131 is shorter than the distance between the center 134c and the end on the B side of the opening 131. Accordingly, in view of the principle of a dual view display, it is understandable that the area capable of transmitting light on the A side of the display section 5 is larger than that on the B side of the display section 5, so that regions of pixels capable of transmitting light on the A side are wider than regions of pixels capable of transmitting light on the B side.

In accordance with the sizes of areas capable of transmitting light in the display regions on the respective A and B sides, the light source emission condition determining section 72 determines a current (or a duty ratio of the current) to be applied to the LED 4A or the LED 4B. Specifically, according to the example shown in (b) of FIG. 13, the current to be applied to the LED 4A is decreased by a predetermined amount so as to decrease luminance of the LED 4A which emits light to the display region on the A side having a larger area capable of transmitting light. Of course, instead of decreasing the current, the duty ratio of the current to be applied to the LED 4A can be decreased by a predetermined ratio. Instead of changing a current to be applied to the LED 4A, a current to be applied to the LED 4B can be changed.

In accordance with the emission condition setting value, the light source driving control section 8 generates a current(s) to be applied to the LED 4A and/or the LED 4B, and applies the current(s) to the LED 4A and/or the LED 4B, thereby driving the LED 4A and/or the LED 4B. Thus, it is possible to optimally control luminances of the display regions on the respective A and B sides of the display section 5.

The present invention may be arranged such that the display device 100 as an end product includes no sensor and luminance is adjusted by using a sensor at the time of pre-shipment check etc. The number of image sensors may be two or more.

### Embodiment 8

The light path changing member 1 is a kind of a so-called optical sheet having functions such as reflection, diffusion, convergence etc. of light which has exited from the light guide plate 2. As has been described, the light path changing member 1 in accordance with Embodiment 8 is a member for at least changing, by way of its optical property, a path of incident light.

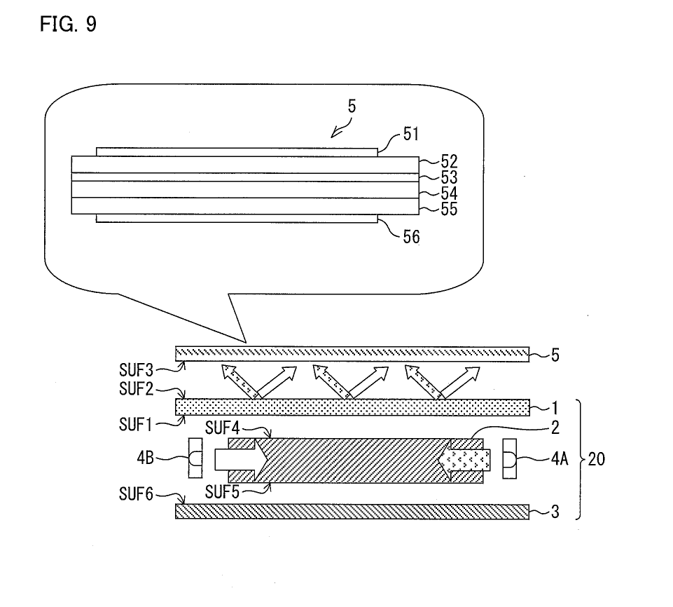

As shown in FIG. 9, the light path changing member 1 has (i) a light-incident surface SUF1 which lights, emitted from the LEDs 4A and 4B that are provided to face each other in a horizontal direction on the drawing sheet, enter and (ii) a light-exit surface SUF2 from which the lights having entered the light-incident surface SUF 1 is emitted. The light-incident surface SUF1 and the light-exit surface SUF2 face each other in a longitudinal direction on the drawing sheet.

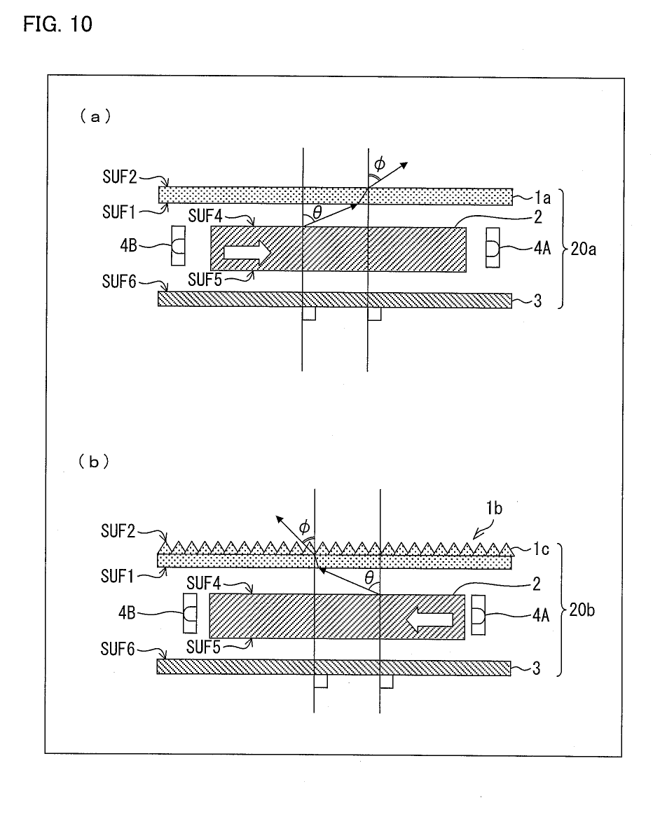

As shown in (a) of FIG. 10 and (b) of FIG. 10, the light path changing member 1 has an optical property in which an exit angle φ (second exit angle), to a direction in which at least two LEDs 4A and 4B face each other, of light which has exited from a light-exit surface SUF4 (second light-exit surface) is made smaller than an exit angle θ (first light-exit angle), to the direction in which the at least two LEDs 4A and 4B face each other, of light which has exited from a light-exit surface SUF2 (first light-exit surface) of the light guide plate 2 (φ<θ).

Examples of the light path changing member 1 (optical sheet) having such an optical property include a diffusion sheet 1a shown in (a) of FIG. 10 and a lens sheet 1b shown in (b) of FIG. 10.

(a) of FIG. 10 shows a configuration of a BL unit (backlight unit) 20a employing the diffusion sheet la as the light path changing member 1. (a) of FIG. 10 shows a configuration of a BL unit (backlight unit) 20b employing the lens sheet 1b as the light path changing member 1.

Note that only the diffusion sheet 1a and the lens sheet 1b will be described below.

The diffusion sheet 1a, shown in (a) of FIG. 10, has minute shapes formed thereon and/or a scattering material dispersed therein. In general, the optical property (φ<θ) of the diffusion sheet 1a has no direction dependency, but the diffusion sheet 1a can be configured such that the diffusion sheet 1a has an optical property merely in a specific direction. In a case where the diffusion sheet 1a is configured such that the optical property has a direction dependency, it is preferable that the diffusion sheet la exhibits an optical property in a direction in which the LEDs 4A and 4B face each other.

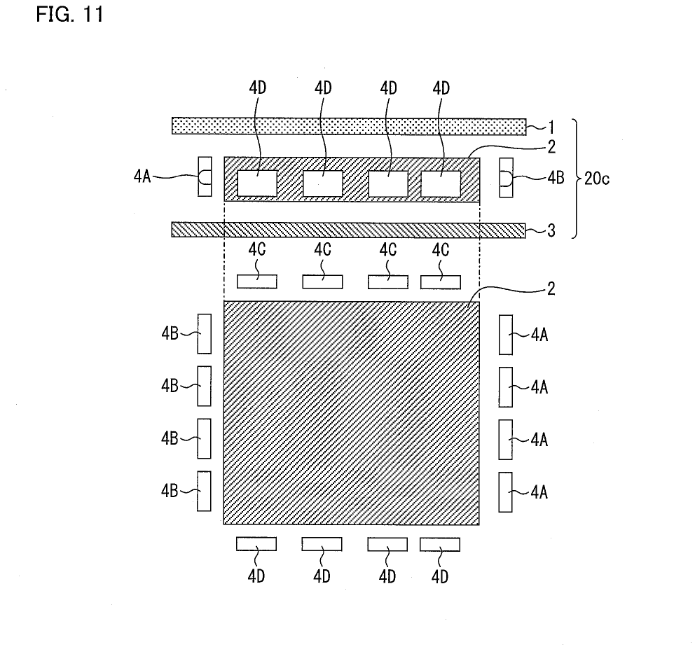

On the other hand, in a case where the optical property has no direction dependency, a diffusion sheet 1a is a bit less effective than the later-described lens sheet 1b. To put it another way, such a diffusion sheet 1a has the optical property (φ<0) in all directions, and is therefore suitable for the light path changing member 1 for CV display, which will be later described (see FIG. 11).

To be more specific, the diffusion sheet 1a in accordance with Embodiment 8 is constituted by a transparent resin and a light diffusing agent (diffusing fine particles) dispersed in the transparent resin.

For example, a thermoplastic resin or a thermosetting resin can be employed as the transparent resin for the diffusion sheet 1a. Examples of the transparent resin include polycarbonate resin, acrylic resin, fluorinated acrylic resin, silicone acrylic resin, epoxyacrylate resin, polystyrene resin, cycloolefin polymer, methylstyrene resin, fluorine resin, polyethylene terephthalate (PET), polypropylene, styrene-acrylonitrile copolymer, and polystyrene-acrylonitrile copolymer.

Transparent particles made of an inorganic material or a resin can be employed as a scattering material (scattering fine particles). Examples of the transparent particles made of an inorganic material include particles made of oxides such as silica (SiO₂), alumina (Al₂O₃), magnesium oxide (MgO), and titania, and other particles such as calcium carbonate and barium sulfate.

Examples of the transparent particles made of a resin include: acrylic resin, styrene resin, acrylicstyrene resin, and cross-linked ones thereof; melamineformaldehyde resin; fluoric resin such as polytetrafluoroethylene, perfluoroalkoxy resin, tetrafluoroethylene-hexafluoropropylene copolymer, polyfluorovinyliden and ethylenetetrafluoroethylene copolymer; and silicone resin.

Since visible light has a wavelength ranging from 350 nm to 800 nm, diffusing fine particles whose particle size is of the same order as the wavelength of visible light (i.e. on the order of 100 nm) can contribute to diffusion of light. To put it the other way around, the particle size of individual diffusing fine particles is required to be not less than 100 nm for expression of optical diffusibility. The particle size of individual diffusing fine particles is preferably on the order of larger than the wavelength of visible light, i.e., not less than 1 μm for suitable expression of optical diffusibility. Accordingly, average particle size of the diffusing fine particles is preferably not less than 1 μm, and more preferably approximately 2 μm.

According to the diffusion sheet 1a, approximately 5 percent by mass of particles for realizing optical diffusibility is contained in the transparent resin. Of course, a mixing ratio of the particles varies a little depending on the degree of desired optical diffusibility (e.g. specified by a Haze value). In a case where the amount of the particles is greatly larger than 5 percent by mass, the Haze value increases needlessly. This causes a distance, by which light is propagated in the diffusion plate, to get longer. This ultimately causes great drop in transmittance.

In a case where the light diffusing particles are employed as the scattering material, it is preferable that the diffusion sheet 1a has a thickness ranging from 0.1 mm to 5 mm. In a case where the thickness of the diffusion sheet 1a ranges from 0.1 mm to 5 mm, optimal diffusion performance and optimal luminance can be obtained, which is preferable in terms of optical properties. In contrast, in a case where the diffusion sheet 1a has a thickness of less than 0.1 mm, a desired diffusion performance cannot be exerted. In a case where the thickness of the diffusion sheet 1a is more than 5 mm, the amount of resin is too large. This causes a decrease in luminance due to absorption of light by the resin, and accordingly each of the two cases is not preferable.

The diffusion sheet 1a in accordance with Embodiment 8 has a Haze value of 75% and whole light transmittance is 86%. Note, however, that it is preferable that a Haze value is not less than 70% and whole light transmittance is not less than 50%.

Consequently, in a case where the exit angle θ of the light guide plate 2 is 70°±5° (first exit angle is not less than 65° and not more than 75°), it is possible to realize the diffusion sheet 1a whose exit angle φ is 45°.

Note that, in a case where a thermoplastic resin is employed as the transparent resin, air bubbles can be employed as the scattering material. Internal surfaces of the respective air bubbles inside the thermoplastic resin cause diffused reflection of light. This allows for expression of light diffusion which is equal to or greater than that obtained in a case where the light diffusing particles are dispersed. This allows the diffusion sheet 1a to have a thinner thickness.

Examples of such a diffusion sheet 1a include white PET and white PP. The white PET is formed by dispersing, in PET, fillers such as resin with no compatibility with PET, titanium oxide (TiO₂), barium sulfate (BaSO₄), and calcium carbonate, and then biaxially stretching the PET so as to generate air bubbles around the fillers.

The diffusion sheet 1a made of the thermoplastic resin may be stretched at least in a uniaxial direction. This is because the stretching at least in a uniaxial direction allows air bubbles to be generated around fillers.

Examples of the thermoplastic resin include, but not limited to, polyester resins such as polystyrene-acrylonitrile copolymer, polyethylene terephthalate (PET), polyethylene-2,6-naphlate, polypropylene terephthalate, polybutylene terephthalate, cyclohexane dimethanol co-polymerized polyester resin, isophthalic acid co-polymerized polyester resin, spiroglycol co-polymerized polyester resin, and fluorene co-polymerized polyester resin; polyolefin resins such as polyethylene, polypropylene, polymethylpentene, and alicyclic olefin co-polymerized resin; acrylic resins such as polymethylmethacrylate; polycarbonate, polystyrene, polyamide, polyether, polyesteramide, polyetherester, polyvinylchloride, and cycloolefin polymer, and copolymers thereof, and mixtures of these resins.

In a case where air bubbles are employed as the scattering material, it is preferable that the diffusion sheet 1a has a thickness ranging from 25 μm to 500 μm.

In a case where the diffusion sheet 1a has a thickness of less than 25 μm, it does not have firm elasticity. This causes the diffusion sheet 1a to be likely to have wrinkles in the manufacture process and in the display. Therefore, such a thickness of less than 25 μm is not preferable. In a case where the diffusion sheet 1a has a thickness of more than 500 μm, the thickness causes problems such as (i) difficulty in rolling the sheet due to increased rigidity and (ii) difficulty in making slits in the diffusion sheet, thereby reducing advantages brought about by thinness, as compared with a conventional diffusion sheet, although optical performance of the diffusion sheet 1a will not be impaired.

The diffusion sheet 1a can have a fine concave and convex structure on the light-incident surface SUF1 or the light-exit surface SUF2. The fine concave and convex structure is formed, for example, in a method in which, during formation of the diffusion sheet 1a, the diffusion sheet 1a is pressed and attached to a mold for giving the fine concave and convex structure by coextrusion molding or injection molding so as to transfer the fine concave and convex structure to the diffusion sheet 1a.

Alternatively, the fine concave and convex structure can be formed, on the light-incident surface SUF1 or the light-exit surface SUF2 of the diffusion sheet 1a, by using a radiation-curing resin such as a UV (Ultra Violet) curing resin. To be more specific, the diffusion sheet 1a is formed as a plate member by coextrusion molding, and then concavities and convexities are formed by UV radiation on the light-incident surface SUF1 or the light-exit surface SUF2 of the diffusion sheet 1a. The fine concave and convex structure is thus formed.

A state of a surface of the light-incident surface SUF1 or the light-exit surface SUF2 is often indicated by roughness of concavities and convexities expressed in a numerical value. Herein, the state of a surface is indicated by a Haze value and an Sm value indicative of intervals at which concavities and convexities are formed (hereinafter “Sm value”). Note that the Haze value is defined by JIS K 7136, and represented as an average of five measurements using a Haze meter. The Sm value is defined by the surface roughness standard JIS B0601-2001, and is an average of measurements made by use of a touching surface roughness meter under a condition that a cut off value is 2.0 mm.

As the Haze value is larger, scattering on the light-incident surface SUF1 or the light-exit surface SUF2 is more frequent. In contrast, as the Haze value is smaller, scattering on the surface is fewer. Similarly, as the Sm value is smaller, concavities and convexities on a surface are finer. When the Haze value is less than 20%, scattering of light on the surface is fewer.

Similarly, when the Sm value is less than 300 μm, intervals at which concavities and convexities are formed on a surface are smaller but roughness of concavities and convexities is insufficient. This causes scattering of light to be weak on the surface. When the Sm value is more than 900 μm, intervals at which concavities and convexities are formed on a surface are large and roughness of the concavities and convexities is worsened. This causes scattering of light to be enhanced on the surface but frontal luminance to be decreased.

The light-incident surface SUF1 or the light-exit surface SUF2 having regular surface roughness is advantageous in terms of bringing about certain scattering effect, as compared with a surface having irregular surface roughness. Furthermore, the light-exit surface SUF2 having regular surface roughness is easier to produce than the surface having irregular surface roughness.

The Haze value can be adjusted in several methods. In a case of forming concavities and convexities physically, such methods include a method in which a surface condition of a mold is adjusted and concavities and convexities are in-line transferred in injection molding or extrusion molding, and a method in which a surface condition of a mold is adjusted and concavities and convexities are formed and then the concavities and convexities are subjected to thermal pressing or abrasive-blasting in an off-line manner. In a case of bleeding out an optical diffusing agent under extrusion conditions, adjustment is made based on concentration and particle size of a diffusing material and a thickness of a diffusing layer.

According to the extrusion method, an extruder heats and melts thermoplastic resin, extrudes the resin from a T die, and molds the resin to have a plate shape. The coextrusion method is employed in a case of forming a laminate plate. In the coextrusion method, using a plurality of extruders, laminates are extruded from a laminate die such as a feed block die and a manifold die, and are formed to be a laminate plate.

Meanwhile, according to the lens sheet 1b shown in (b) of FIG. 10, a plurality of prism columns 1c in accordance with Embodiment 8 are formed on the light-exit surface SUF2, and a ridgeline of the prism columns 1c (axis of prisms) is provided so as to be perpendicular to a direction in which the LEDs 4A and 4B face each other. Consequently, when light which has entered, at a predetermined angle, the lens sheet 1b along a propagation direction of lights emitted from the LEDs 4A and 4B has exited from the light-exit surface SUF2 of the lens sheet 1b, the exit angle φ of the exited light is smaller than an incident angle θ of the light which has entered the lens sheet 1b. This does not cause a problem that it is difficult to emit backlights having luminance directivities in different directions.

According to the lens sheet 1b in accordance with Embodiment 8, each of the prism columns 1c has a cross section of isosceles triangle with an apex angle (prism apex angle) of 80° to 100°, and has a refractive index of 1.5. With the configuration, when the exit angle θ of the light guide plate 2 is 65°±5° (first exit angle is not less than 60° and not more than 70°), the exit angle φ of the lens sheet 1b can be 45°. Note that, as the refractive index of the lens sheet 1b is larger, the exit angle φ of the lens sheet 1 is closer to 0°.

In the BL unit 20 in accordance with the present embodiment, the light path changing member 1 has an optical property in which the exit angle φ, to a direction in which at least two LEDs 4A and 4B face each other, of light which has exited from the light-exit surface SUF2 is made smaller than the incident angle θ, to the direction in which the at least two LEDs 4A and 4B face each other, of light having entered the light-incident surface SUF1. Consequently, as shown in FIG. 9, light emitted from the LED 4A can become backlight whose luminance directivity is inclined leftward with respect to a normal of the light-exit surface SUF2 (inclined toward the A side, for example, at an angle corresponding to a viewing angle+45°). On the other hand, light emitted from the LED 4B can become backlight whose luminance directivity is inclined rightward with respect to a normal of the light-exit surface SUF2 (inclined toward the B side, for example, at an angle corresponding to a viewing angle−45°).

Since an axis of the prism columns is along a propagation direction of light emitted from the light sources, there does not arise a problem that it is difficult to emit backlights having luminance directivities in different directions.

Furthermore, as shown in FIG. 9, light which has exited from the light-exit surface SUF2 of the light path changing member 1 directly illuminates the display section 5 which is provided outside the BL unit 20. In other words, according to the BL unit 20, an optical sheet between the display section 5 and the light guide plate 2 (later described) is constituted by only the light path changing member 1. As such, there is no problem of difficulty in thinning the BL unit 20.

According to the BL unit 20, it is possible to emit backlights having respective luminance directivities in different directions, while thinning the BL unit 20.

The light guide plate 2 is provided for receiving lights emitted from the respective LEDs 4A and 4B and guides received lights to the light-incident surface SUF 1 of the light path changing member 1 from the light-exit surface SUF4.

To be more specific, the light guide plate 2 is a transparent resin plate which converts linear lights emitted from the LEDs 4A and 4B into a surface light source so that surface lights can enter the display section 5.

The light guide plate 2 has a plate shape (rectangular solid shape), and the light-exit surface SUF4 (bottom surface SUF5) has a rectangular shape. The light guide plate 2 has a thickness which falls within a range of 0.2 mm to 3 mm. Note, however, that the thickness of the light guide plate 2 is not limited to such a range.

According to Embodiment 8, the light guide plate 2 has a plate shape. Note, however, that Embodiment 8 is not limited to such. Alternatively, the light guide plate 2 can have various shapes such as a wedge-shape and a boat-shape. Examples of a material for the light guide plate 2 encompass synthetic resins with high transmittance, such as methacrylic resin, acrylic resin, polycarbonate resin, polyester resin, and vinyl chloride resin. The light guide plate 2 is designed in such a manner that the light-exit surface SUF4 has a mirror surface and the bottom surface SUF5 which is opposite to the light-exit surface SUF4 has a rough surface.

The light guide plate 2 has a bottom surface SUF5 which has been subjected to a prism treatment, a dot printing treatment etc. so as to equalize or increase luminance.

According to a specific example of the light guide plate 2 in accordance with Embodiment 8, concavities and convexities are sparser as the concavities and convexities are closer to the LEDs 4A and 4B (as the concavities and convexities are closer to ends of the light guide plate 2), whereas the concavities and convexities are denser as the concavities and convexities are farther from the LEDs 4A and 4B (as the concavities and convexities are closer to the center of the light guide plate 2). Note, however, that concavities and convexities on the light guide plate 2 are not limited to such. Since the light guide plate 2 is thus configured, the light guide plate 2 emits light evenly in a right upward direction or left upward direction (see FIG. 9).

Examples of a method for forming concavities and convexities on the bottom surface SUF5 of the light guide plate 2 include (i) a method of forming the light guide plate 2 by injection molding by use of a mold with concavities and convexities and (ii) a method of (a) forming a light guide member with a flat surface by injection molding or casting and then (b) carrying out screen printing in which the light guide member is printed in exclusive ink so as to have protrusions thereon.

The reflective sheet 3 is a light reflective member which reflects light which has leaked from the bottom surface SUF5 of the light guide plate 2. The reflective sheet 3 has a flat surface.

A material for the reflective sheet 3 is (i) a film made of polyester resin or polyolefin resin or (ii) a white film. The white film is obtained by, before forming in a film shape or a sheet shape, adding to a plastic resin a pigment such as titanium oxide, barium sulfate, calcium carbonate, aluminum hydroxide, magnesium carbonate, and aluminum oxide so that the plastic film shows white color. an alternative film for the reflective sheet 3 can be prepared by carrying out the steps of (a) forming a film by causing a resin to contain inorganic filler such as calcium carbonate and titanium oxide and (b) stretching the film so that the film has a number of microvoids therein.

The LEDs 4A and 4B allows for (i) uniform luminance in a backlight plane and (ii) bilateral symmetry of distribution of light distribution angle for light emission from the backlight plane.

In a case where the plurality of light sources are CCFTs, a single horseshoe fluorescent tube can be employed in which two light sources are connected with each other. Two L-shaped fluorescent tubes in combination can be employed as the plurality of light sources.

A reflector (not shown) may be provided for each of the LEDs 4A and 4B. Each reflector has an inner surface which is parabolic, and a corresponding one of the LEDs 4A and 4B is provided at a focal point of the parabolic shape.

As shown in FIG. 9, the display section 5 has a light-illumination surface SUF3 which is directly illuminated by light which has exited from the light-exit surface SUF4 of the light guide plate 2. The display section 5 includes polarizers 51 and 56, a parallax barrier 52, an adhesive layer 53, a CF (color filter) substrate 54, and a TFT (thin film transistor) substrate 55.

Each of the polarizers 51 and 56 is constituted by a polarizing base material containing a polarizing element, base substrates (not shown) between which the polarizing base material is sandwiched, a protection film (not shown) on one side, and a releasing film (not shown) on the other side which film is to be attached to a glass substrate.

Each of the polarizers 51 and 56 has a thin thickness of approximately at most 0.12 mm to 0.4 mm even in a case where the polarizer 51 or 56 is made up of ten or so. In the polarizing base material containing a polarizing element, iodine or dichroic dye serves as the polarizing element which brings about a polarization effect. Polyvinyl alcohol (PVA) is employed as the polarizing base material, and the polarizing element is contained in the polyvinyl alcohol (medium). Triacetyl cellulose (TAC, cellulose triacetate) is employed as the base substrate which functions to protect the polarizing base material. The releasing film has an adhesive layer which is applied to a base-substrate side of the releasing film. The releasing film is peeled off when the polarizers 51 and 56 are attached to the glass substrate, and then the polarizers 51 and 56 are attached to the glass substrate via the adhesive layer.

The parallax barrier 52 is an optical member in which light transmittance regions and light blocking regions are provided in a striped manner. The parallax barrier 52 separates a plurality of images to be displayed in respective display regions.

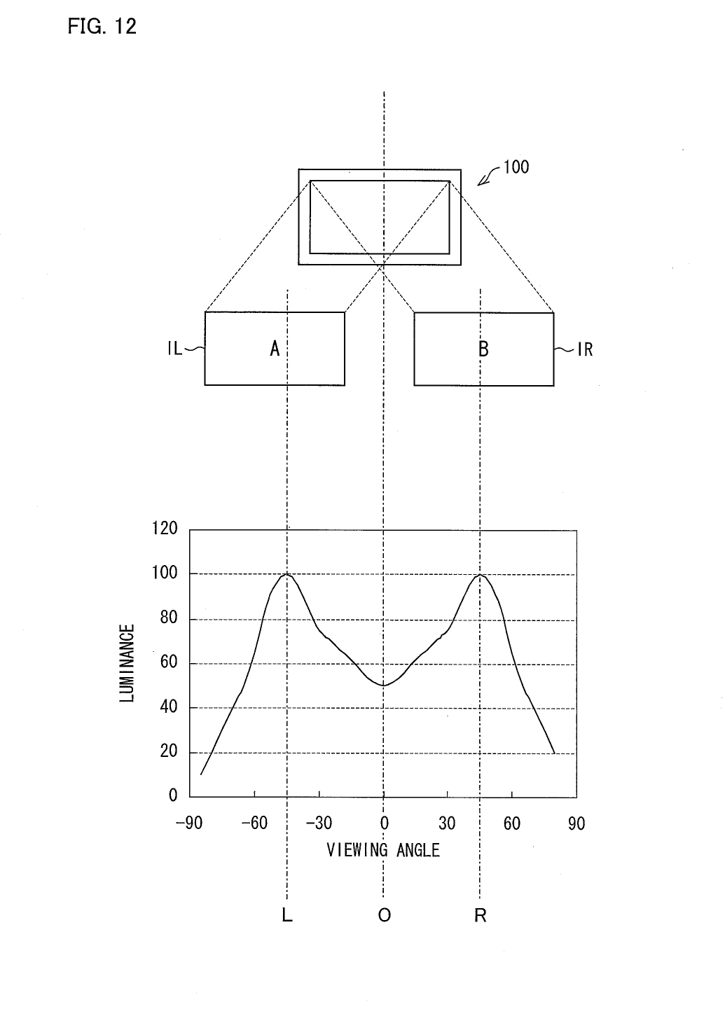

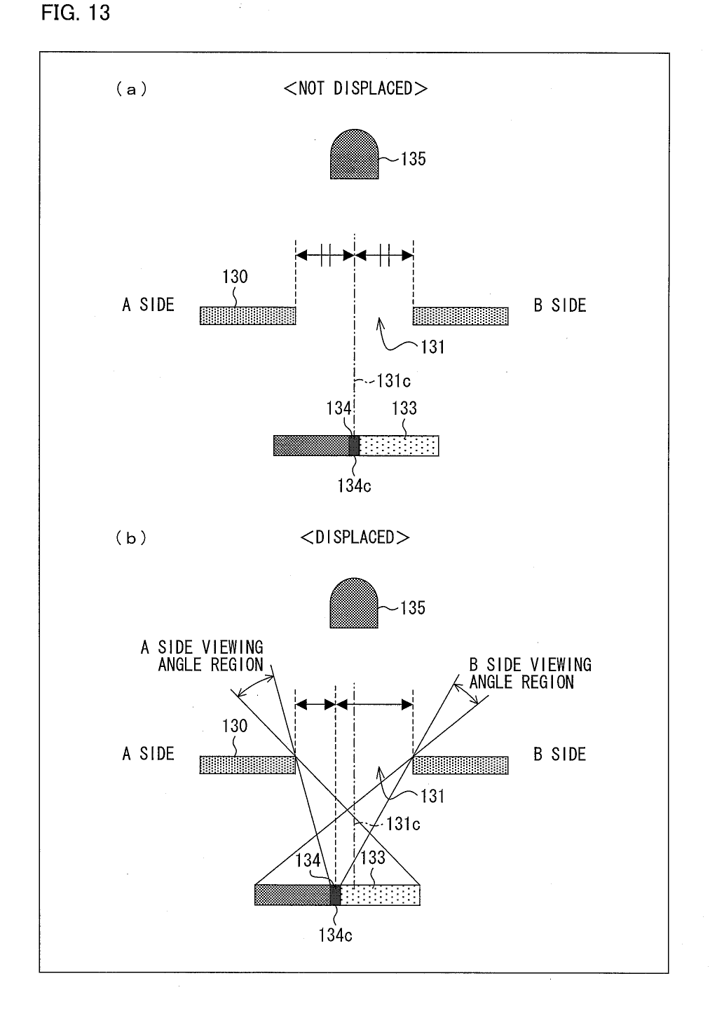

For example, the parallax barrier 52 allows DV display in which first users and second users in first and second directions specified by specific viewing angles L and R to view a left-side image IL (on A side) and a right-side image IR (on B side), respectively, which are different images (see for example FIG. 12).

The adhesive layer 53 is a transparent resin layer, made of acrylic resin etc., via which the parallax barrier 52 is adhered to the CF substrate 54. Note that, if the parallax barrier 52 and the CF substrate 54 are formed while contacting each other, then the parallax barrier 52 cannot serve as a parallax barrier. In view of the circumstances, the adhesive layer 53 is provided to appropriately adjust a distance between the parallax barrier 52 and the CF substrate 54. Note that the distance is not particularly limited, provided that the distance allows for DV display.

According to the CF substrate 54, (i) coloring layers which transmit red (R), green (G), and blue (B) lights for respective pixels, black matrix (BM), and the like are provided on a substrate, and the substrate thus provided is covered with a protective film. The coloring layer is a coloring material or a coloring film which is applied to the CF substrate 54 in a fine pattern. A pigment or dye is used for the coloring layer. The BM layer prevents (i) leakage of light during black display, (ii) adjacent coloring materials from being mixed with each other, and (iii) generation of a photoelectric current due to irradiation of the TFT substrate 55 with light. In a case where a photosensitive material is used to fix the coloring material, the photosensitive material is mixed with the coloring material and is fixed as it is. The BM layer of approximately 0.1 μm in thickness is often made of chromium metal. Other examples of the material for the BM layer include carbon, titanium, and nickel. Three colors of coloring layers which are thicker than the BM layer of approximately 1.2 μm are provided, between the BM layers, in a predetermined pattern. In a case of a high definition screen, it is often the case that the pattern for the coloring layers is a stripe pattern. However, in a case of a low definition screen, a delta pattern gives a viewer an impression of satisfactory image quality.

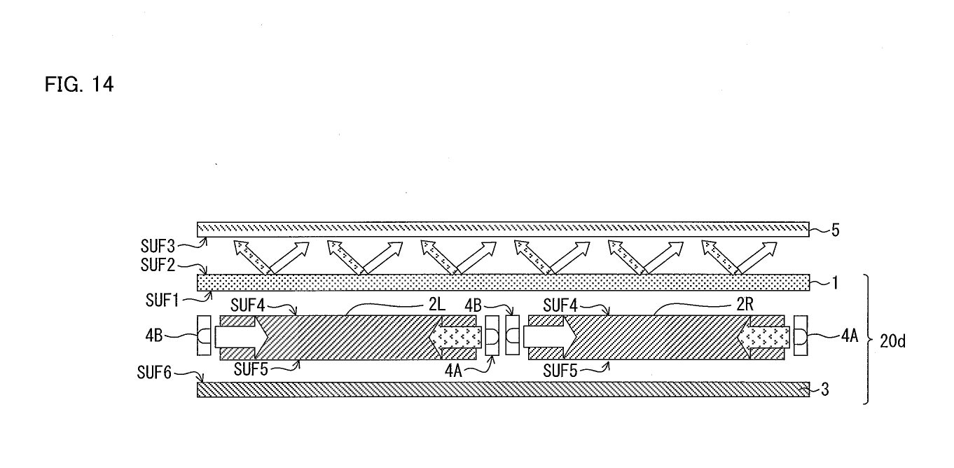

The following description will discuss, with reference to FIG. 14, the other configuration of the BL unit. FIG. 14 shows a BL unit (backlight unit) 20d which is still another configuration example of the backlight unit.

The BL unit 20d is different from the BL units 20a, 20b, and 20c in that a plurality of light guide plates 2 (and corresponding light sources 4A and 4B) are provided in a right-left direction.

For example, in FIG. 14, two light guide plates 2L and 2R are provided adjacently in a horizontal direction (right-left direction) when the liquid crystal panel 5 is viewed from above. Each of the light guide plates 2L and 2R has the same configuration as the light guide plate 2, and LEDs 4A and 4B are provided at both ends of the light guide plate 2L, and LEDs 4A and 4B are provided at both ends of the light guide plate 2R. Note that the number of set of each light guide plate 2 and corresponding LEDs 4A and 4B is not limited to two as shown in FIG. 14, and can therefore be four or more depending on the size of the display section 4. These sets can be provided in a so-called tiling manner.

In general, when light is reflected more than once in a light guide plate, the amount of light gradually attenuates at lower wavelengths, resulting in a change in color. As such, in a case where a single light guide plate is provided in a large liquid crystal panel, the number of reflections of light in the light guide plate increases. This causes a problem that a color on a side farther from a light source will be greatly changed as compared with that on a side closer to the light source. In this regard, according to the above configuration, since a plurality of light guide plates (light guides 2L and 2R in FIG. 14) are provided side by side, each light guide plate can be downsized. This allows a reduction in the number of reflections of light in each light guide plate. It is therefore possible to enlarge the liquid crystal panel 5 while making the BL unit 20d thinner, without a change (variation) in color.

It is preferable to arrange the display device of the present invention such that the plurality of light sources emit light including a predetermined color, said either one or a plurality of sensors further measure chromaticities of lights emitted from the plurality of display regions, and in accordance with a result of chromaticities measured by said either one or a plurality of sensors, the operation section adjusts chromaticities of the plurality of light sources which illuminate the respective plurality of display regions.

With the arrangement, in accordance with chromaticities of lights emitted from the plurality of display regions of the display section, the operation section adjusts chromaticities of the plurality of light sources. With the arrangement, the adjustment is made by using lights emitted from the display section, so that adjustment of chromaticities of images respectively displayed in the display regions can be made in consideration of a cause which would change chromaticity of light having entered the display section (i.e. light having entered the panel).

Therefore, the arrangement allows chromaticities of images respectively displayed in different display regions to be made substantially equal to each other. This ultimately allows a quality of an image to be adjusted under a circumstance similar to real conditions.

An example of a light source which emits light including a predetermined color is an RGB (Red Green Blue)-LED (Light Emitting Diode).

It is preferable to arrange the display device of the present invention such that said either one or a plurality of sensors is a plurality of sensors for measuring luminances of lights emitted from the plurality of display regions.

It is preferable to arrange the display device of the present invention such that the plurality of display regions display images during respective different time periods, and said either one or a plurality of sensors are one sensor which measures luminances emitted from the plurality of display regions during respective different periods.

With the arrangement, in the present invention, both in a case where there is provided one sensor and a case where there are provided a plurality of sensors, it is possible to measure luminances of lights emitted from the display regions.

It is preferable to arrange the display device of the present invention such that emission of each of the plurality of light sources is controlled by controlling a corresponding current, and the operation section carries out at least one of (i) a process for decreasing a current to be applied to a light source of the plurality of light sources which illuminates a corresponding display region of the plurality of display regions from which light with higher luminance is emitted and (ii) a process for increasing a current to be applied to a light source of the plurality of light sources which illuminates a corresponding display region of the plurality of display regions from which light with lower luminance is emitted.

It is preferable to arrange the display device of the present invention such that emission of each of the plurality of light sources is controlled by pulse width modulation, and the operation section carries out at least one of (i) a process for decreasing a duty ratio of a current to be applied to a light source of the plurality of light sources which illuminates a corresponding display region of the plurality of display regions from which light with higher luminance is emitted, and (ii) a process for increasing a duty ratio of a current to be applied to a light source of the plurality of light sources which illuminates a corresponding display region of the plurality of display regions from which light with lower luminance is emitted.

With the arrangement, emission of the light source of the present invention may be controlled by controlling a current in accordance with a value of a current, or by pulse width modulation in accordance with a pulse width (duty ratio) of a current.

It is preferable to arrange the display device of the present invention such that the number of the plurality of light sources is two or four.

Since the plurality of light sources illuminate different display regions, a display device including a display section being a dual view display requires two light sources, and a display device including a display section being a quartet view display requires four light sources.

It is preferable to arrange the display device of the present invention such that a parallax barrier for separating images into the plurality of display regions is attached to the display section, and said either one or a plurality of sensors are an image sensor for measuring an amount of displacement in attaching the parallax barrier to the display section.

A dual view display is designed to separate images in two directions by a parallax barrier attached to a display section. Accordingly, there would be a possibility that displacement in attaching the parallax barrier to the display section varies areas capable of transmitting light in display regions of the display section, resulting in difference in luminance between the display regions.

With the arrangement, even if there is displacement in attaching the parallax barrier to the display section, it is possible to cause luminances of images displayed in different display regions to be substantially equal to each other.

It is preferable to arrange the display device of the present invention such that the plurality of light sources are two light sources provided so as to face each other, the display device includes a light guide member and a light path changing member, the light guide member, which receives lights from the respective two light sources, having a first light-exit surface via which received lights exit, and the light path changing member, which receives the lights having exited from the first light-exit surface of the light guide member, having a second light-exit surface via which received lights exit toward the display section, so as to change a path of light passing through the light path changing member, and the light path changing member emits, from the second light-exit surface, lights each having luminance directivity such that luminance distribution has a maximum luminance value at least in one direction different from a normal direction of a display screen of the display section, said at least one direction of the maximum luminance value of the luminance distribution of one of the lights being different from that of the other.

With the arrangement, the display device of the present invention can emit lights having respective luminance directivities in different directions, while the display device is made thinner.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to a display device including a plurality of light sources which illuminate different display regions. Examples of such a display device include a dual view display and a quartet view display.

### REFERENCE SIGNS LIST

1 Light path changing member
2 Light guide plate
3 Reflective sheet
4A-4D LED (light source)
5 Display section
6, 6A-6D Sensor
7 Operation section
8 Light source driving control section
10 Memory
71 Data analysis section
72 Light source emission condition determining section
73 Operation section memory
100, 110 Display device
300 Backlight section

1. A display device, comprising:
a display section having a plurality of display regions;
a plurality of light sources for illuminating the respective plurality of display regions which are different from each other;
either one or a plurality of sensors for measuring luminances of lights emitted from the plurality of display regions; and
an operation section for carrying out, in accordance with a result measured by said either one or a plurality of sensors, at least one of (i) a process for decreasing a luminance of a light source of the plurality of light sources which illuminates a corresponding display region of the plurality of display regions from which light with higher luminance is emitted and (ii) a process for increasing a luminance of a light source of the plurality of light sources which illuminates a corresponding display region of the plurality of display regions from which light with lower luminance is emitted.

2. The display device as set forth in claim 1, wherein:
the plurality of light sources emit light including a predetermined color,
said either one or a plurality of sensors further measure chromaticities of lights emitted from the plurality of display regions, and
in accordance with a result of chromaticities measured by said either one or a plurality of sensors, the operation section adjusts chromaticities of the plurality of light sources which illuminate the respective plurality of display regions.

3. The display device as set forth in claim 1, wherein said either one or a plurality of sensors is a plurality of sensors for measuring luminances of lights emitted from the plurality of display regions.

4. The display device as set forth in claim 1, wherein:
the plurality of display regions display images during respective different time periods, and
said either one or a plurality of sensors are one sensor which measures luminances emitted from the plurality of display regions during respective different periods.

5. The display device as set forth in claim 1, wherein
emission of each of the plurality of light sources is controlled by controlling a corresponding current, and
the operation section carries out at least one of (i) a process for decreasing a current to be applied to a light source of the plurality of light sources which illuminates a corresponding display region of the plurality of display regions from which light with higher luminance is emitted and (ii) a process for increasing a current to be applied to a light source of the plurality of light sources which illuminates a corresponding display region of the plurality of display regions from which light with lower luminance is emitted.

6. The display device as set forth in claim 1, wherein
emission of each of the plurality of light sources is controlled by pulse width modulation, and
the operation section carries out at least one of (i) a process for decreasing a duty ratio of a current to be applied to a light source of the plurality of light sources which illuminates a corresponding display region of the plurality of display regions from which light with higher luminance is emitted, and (ii) a process for increasing a duty ratio of a current to be applied to a light source of the plurality of light sources which illuminates a corresponding display region of the plurality of display regions from which light with lower luminance is emitted.

7. The display device as set forth in claim 1, wherein the number of the plurality of light sources is two or four.

8. The display device as set forth in claim 1, wherein
a parallax barrier for separating images into the plurality of display regions is attached to the display section, and
said either one or a plurality of sensors are an image sensor for measuring an amount of displacement in attaching the parallax barrier to the display section.

9. The display device as set forth in claim 1, wherein
the plurality of light sources are two light sources provided so as to face each other,
the display device includes a light guide member and a light path changing member, the light guide member, which receives lights from the respective two light sources, having a first light-exit surface via which received lights exit, and the light path changing member, which receives the lights having exited from the first light-exit surface of the light guide member, having a second light-exit surface via which received lights exit toward the display section, so as to change a path of light passing through the light path changing member, and
the light path changing member emits, from the second light-exit surface, lights each having luminance directivity such that luminance distribution has a maximum luminance value at least in one direction different from a normal direction of a display screen of the display section, said at least one direction of the maximum luminance value of the luminance distribution of one of the lights being different from that of the other.

10. A method of controlling a display device which includes a display section having a plurality of display regions, and a plurality of light sources for illuminating the respective plurality of display regions which are different from each other;
the method comprising the steps of:
measuring luminances of lights emitted from the plurality of display regions by use of either one or a plurality of sensors; and
carrying out, in accordance with a result measured by said either one or a plurality of sensors, at least one of (i) a process for decreasing a luminance of a light source of the plurality of light sources which illuminates a corresponding display region of the plurality of display regions from which light with higher luminance is emitted and (ii) a process for increasing a luminance of a light source of the plurality of light sources which illuminates a corresponding display region of the plurality of display regions from which light with lower luminance is emitted.
